(19) United States
(12) Patent Application Publication
(10) Pub. No.: US 2025/0163340 A1
(43) Pub. Date: May 22, 2025

(54) PROCESS FOR PRODUCING SOLID BIOMASS FUEL

(71) Applicant: Mei Hong Bai, Hong Kong (CN)

(72) Inventor: Mei Hong Bai, Hong Kong (CN)

(21) Appl. No.: 18/839,655

(22) PCT Filed: Feb. 20, 2023
(86) PCT No.: PCT/GB2023/050378

§ 371 Date: Aug. 19, 2024

(30) Foreign Application Priority Data
Feb. 18, 2022 (GB) 2202235.4

(51) Int. Cl. C10L 5/44

(52) U.S. Cl. CPC C10L 5/445; C10L 2200/0469; C10L 2290/28; C10L 2290/30

(57) ABSTRACT

A process for producing a solid biomass fuel, wherein the process comprises the following steps: (i) providing a biomass composition comprising biomass particles with an average particle diameter (D50) of from 1,000 m to 75,000 m; (ii) pulverising the biomass composition to provide a pulverised biomass powder with an average particle diameter (D50) of from 500 m to 10,000 m; (iii) drying the pulverised biomass powder so as to provide a dried pulverised biomass powder; (iv) molding the dried pulverised biomass powder so as to provide a molded biomass product; (v) heating the molded biomass product to a temperature of from 110 C to 500 C for a time period of from 0.2 to 6 hours so as to provide a solid biomass fuel; wherein the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

### FIELD OF THE INVENTION

The present invention relates to a process for producing a solid biomass fuel, as well as a solid biomass fuel produced by said process. Additionally, the present invention relates to a combustion process comprising combusting said solid biomass fuel so as to produce energy.

### BACKGROUND OF THE INVENTION

Coal-fired power generation is used in power plants and industrial processes around the world. Coal and other fossil fuels are non-renewable energy resources. Over the last few decades, there have been calls to reduce the consumption of coal in coal-fired power stations and instead to use renewable resources for energy.

Fuels derived from biomass are an example of a renewable energy source that can be used to replace or at least partially replace coal. Biomass derived fuels can be burned in the presence of oxygen in power plants in combustion processes to produce energy. Biomass derived fuels can be combusted in traditional power plants originally designed for coal combustion, or biomass derived fuels can be combusted in power plants built specifically for biomass combustion. Certain forms of biomass can be mixed with coal and combusted in the same combustion process within a power plant. Such a process is known as coal co-firing of biomass. To be suitable for co-firing with coal, biomass derived fuel must typically have certain properties such as a certain level of quality and homogeneity with regard to properties. For example, biomass fuel comprised of particles of a homogenous size, density, moisture content etc. are particularly desirable in co-firing processes. It is also desirable that the biomass fuel contains a low level of ash. Levels of ash in biomass derived fuels are typically higher than those found in coal.

Various processes for producing solid biomass fuels from biomass sources are known. WO2016/056608, WO2017/175733 and WO2019/069849 discloses processes for forming solid biomass fuels from various sources of biomass in processes that involve pulverising sources of biomass; molding the pulverised biomass into pellets; and then heating the molded biomass pellets so that the biomass undergoes torrefaction so as to form solid biomass fuel particles. Whilst the processes disclosed in these documents can provide solid biomass fuels with desirable properties such as reasonably high bulk density, mechanical durability, and water resistance, the processes disclosed in these documents are limited to the use of wood-like biomass sources such as rubber trees, acacia trees, radiata pine, larch, spruce, birch, pine and fir. The above documents teach that the use of such wood-like biomass starting materials is necessary to provide solid biomass fuels with the performance properties discussed above.

However, it is known by those of skill in the art that the solid biomass fuels and processes for their production discussed in the above documents have various problems associated with them. For example, the wood-like biomass sources described in the above documents typically only occur naturally and are not easy to cultivate and harvest on a commercial scale. Additionally, the wood-like sources of biomass described in the above documents, when subjected to conventional pulverising techniques, form particles with a low degree of homogeneity. Furthermore, pulverising the biomass sources is expensive due to the nature of the wood and wood-like material. It has also been found that the biomass fuel production processes described above do not provide fuels with sufficient quality and uniformity. This is believed to be due to e.g. the lack of homogeneity in the pulverised biomass materials, and also a lack of control of the process during the molding step.

In light of the above problems, there is a need in the art for a process for producing high performance solid biomass fuels from alternative sources of biomass (i.e. non-woody biomass sources). Particular solutions to these problems are disclosed in WO2020/229824, WO2021/014151, WO2021/024001 and WO2021/156628 and seek to ameliorate the problems discussed above. However, despite the processes taught in these documents, there remains a continued need in the art for high performance solid biomass fuels derived from non-wood like forms of biomass and processes for their manufacture. It has also been appreciated by the inventors of the present invention that the processes taught in these documents often do not provide solid biomass fuels with very high mechanical durability. Whilst the disclosed processes have been found to provide solid biomass fuels with a mechanical durability of greater than 90%, it has not always been found possible to provide solid biomass fuels with a mechanical durability of 97% or greater. In WO2020/229824 and WO2021/014151, it was only possible to achieve mechanical durabilities of 97% or greater by including a substantial amount of wood-like biomass in the solid biomass fuels. This is undesirable for the reasons explained above. In WO2021/024001 and WO2021/156628, mechanical durabilities of 97% or greater were only found to be achievable with certain specific types of biomass material. There is thus a continued need in the art for processes for making solid biomass fuel from non-woody biomass sources that produce a solid biomass fuel with very high mechanical durabilities (i.e. of 97% or more). A high mechanical durability for the solid biomass fuels is advantageous since fuels with high durability have been found to be able to be stored outside without damage for periods as long as two months without being damaged by rainfall and other adverse weather conditions. High mechanical durability is also desirable since durable fuels are less likely to disintegrate and fall apart or form dust during processing, transport or storage.

In addition to the above, it has been appreciated by the inventors that whilst the processes taught in the above documents provide solid biomass fuels with various high performance properties such as high bulk density, mechanical durability, and water proof properties that are comparable to the fuels derived from wood-like sources disclosed in e.g. WO2016/056608, WO2017/175733 and WO2019/069849, these properties were achieved by using high compression ratios during the step of molding pulverised sources of biomass into pellets. The compression ratio for a compression mold is the ratio of the length to the diameter of the mold product exit hole of the compression mold. As discussed in e.g. WO2021/156628, a higher compression ratio has been found by the inventors to typically produce solid biomass fuels with better performance properties such as high bulk density, mechanical durability, uniformity and water resistance. However, a higher compression ratio has also been found by the inventors to be associated with a lower process yield. Additionally, higher compression ratios typically involve the need to use higher pressures during the molding step which increases the cost of the production processes. It is thus taught that there is a balance to be reached between a too high and too low compression ratio in the molding step of the fuel production processes. In WO2020/229824, WO2021/014151, WO2021/024001 and WO2021/156628, it is taught that the use of a compression ratio of from 3.8 to 6.5 is important for achieving solid biomass fuels with the high performance properties discussed above. The inventors of the present invention have appreciated that there remains a need in the art for processes for producing high performance solid biomass fuels from non-wood biomass sources where the high performance properties can be achieved with the use of a lower compression ratio, thus increasing the process yield and the costs of the process.

### SUMMARY OF THE INVENTION

The present invention seeks to address the problems discussed above associated with prior processes. It has surprisingly been found by the inventors of the present invention that certain non-wood sources of biomass can be converted into high performance solid biomass fuels using certain specific manufacturing steps. Surprisingly, the use of said specific biomass sources in combination with the specific process steps has been found to provide solid biomass fuels with particularly high mechanical durabilities of 97% or greater, as well as comparative high bulk densities, water-proof properties and high uniformity to the fuels taught in WO2020/229824, WO2021/014151, WO2021/024001 and WO2021/156628. Additionally, it has surprisingly been found that using the specific biomass sources in combination with the specific process steps, the advantageous properties discussed above can be achieved with a much lower compression ratio in the molding step. This is surprising since it was previously believed that a higher compression ratio of at least 3.6 was important for providing such high performance properties. The surprising finding that the above properties can be achieved with the use of a lower compression ratio means that the yield of the solid fuel production process is increased and the costs of the overall process may also be reduced by avoiding the higher pressures associated with the use of higher compression ratios.

According to a first aspect of the invention, there is provided a process for producing a solid biomass fuel, wherein the process comprises the following steps:
(i) providing a biomass composition comprising biomass particles with an average particle diameter (D50) of from 1,000 μm to 75,000 μm;
(ii) pulverising the biomass composition to provide a pulverised biomass powder with an average particle diameter (D50) of from 500 μm to 10,000 μm;
(iii) drying the pulverised biomass powder so as to provide a dried pulverised biomass powder;
(iv) molding the dried pulverised biomass powder so as to provide a molded biomass product;
(v) heating the molded biomass product to a temperature of from 110° C. to 500° C. for a time period of from 0.2 to 6 hours so as to provide a solid biomass fuel;
wherein the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

Where the biomass composition comprises hemp, typically, the hemp is selected from ramie, jute, green flax, flax, rooibos, kenaf, or combinations thereof.

Typically, the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof in an amount of from 50% to 100% by weight.

Preferably, the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof in an amount of from 80% to 100% by weight.

More preferably, the biomass composition consists essentially of rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

Alternatively, the biomass composition may further comprise further sources of biomass. For example the biomass composition may further comprise rice husk, peanut shells, legume straw, or any combination thereof. For example, the biomass composition may comprise rice husk, legume straw, or any combination thereof in an amount up to 80% by weight of the composition, such as up to 60% by weight, 50% by weight, 40% by weight, 30% by weight, 20% by weight or 10% by weight of the biomass composition.

Typically, the biomass composition comprises less than 50% by weight of woody biomass. Preferably, the biomass composition comprises less than 20% by weight of woody biomass.

More preferably, the biomass composition comprises less than 10% by weight of woody biomass, or less than 5% by weight of woody biomass. Most preferably, the biomass composition is essentially free of, or free of woody biomass.

Typically, the solid biomass fuel comprises material derived from the biomass composition in an amount of at least 75% by weight; and preferably at least 80% by weight. Preferably, the solid biomass fuel comprises material derived from the biomass composition in an amount of at least 90% by weight. More preferably, the solid biomass fuel consists essentially of or consists of material derived from the biomass composition.

The moisture content of the biomass composition may be 20% by weight or less; such as 18% by weight or less or 15% by weight or less. In these instances, typically, step (ii) of pulverising the biomass composition to provide a pulverised biomass powder with an average particle diameter (D50) of from 500 μm to 10,000 μm comprises crushing the one or more sources of biomass in a process involving the use of a negative pressure pneumatic conveyancing apparatus. Alternatively, the moisture content of the biomass composition may be 20% by weight or higher.

Typically, the process further comprises passing the pulverised biomass powder through a screen after pulverisation; optionally wherein the screen comprises apertures with a largest diameter of 8 mm or less; preferably 3 mm or less; and more preferably 3 mm or less.

Preferably, the pulverised biomass powder has a particle size of from 500 μm to 8,000 μm; more preferably from 500 μm to 5,000 μm.

Typically, step (iii) of drying the pulverised biomass powder so as to provide a dried pulverised biomass powder comprises drying the pulverised biomass in a drying cylinder. Where the moisture content of the pulverised biomass powder is 20% by weight or less, the process typically comprises drying the pulverised biomass powder in a single drying cylinder. Where the moisture content of the pulverised biomass powder is 20% by weight or more, the process typically comprises drying the pulverised biomass powder in multiple drying cylinders.

Typically, step (iv) of molding the dried pulverised biomass powder comprises adapting the molding step such that the density of the molded biomass product is controlled. Preferably, adapting the molding step such that the density of the molded biomass product is controlled comprises controlling the compression ratio of a mold used in said molding step.

Typically, step (iv) of molding the dried pulverised biomass powder so as to provide a molded biomass product comprises molding the pulverised biomass powder with a compression mold with a compression ratio of less than 6; and preferably less than 5. More preferably, step (iv) of molding the dried pulverised biomass powder so as to provide a molded biomass product comprises molding the pulverised biomass powder with a compression mold with a compression ratio of less than or equal to 3.5; and most preferably less than or equal to 3 such as from 1 to 3.

Preferably, an additive is added to the dried pulverised biomass powder prior to step (iv) of molding the dried compressed biomass powder. Examples of suitable additives include binders.

Preferably, step (v) of heating the molded biomass product is carried out for a time period of from 0.3 to 2.5 hours. Preferably, the step of heating the molded biomass product comprises heating the molded biomass product to a temperature of from 220° C. to 350° C. and more preferably from 220° C. to 320° C. More preferably, step (v) of heating the molded biomass product is carried out for a time period of from 0.3 to 2.5 hours and the step of heating the molded biomass product comprises heating the molded biomass product to a temperature of from 220° C. to 350° C., such as from 220° C. to 320° C.

Typically, step (v) of heating the molded biomass product comprises heating the molded biomass product under conditions so as to induce torrefaction of the molded biomass product.

Typically, step (v) of heating the molded biomass product is adapted so as to control the uniformity of the solid biomass fuel, preferably wherein adapting step (v) so as to control the uniformity of the solid biomass fuel comprises conducting step (v) in an apparatus in which the molded biomass product is rotated whilst being heated. More preferably, step (v) is adapted so as to control the uniformity of the solid biomass fuel by controlling the speed or direction of rotation of the molded biomass product such as by rotating the molded biomass product is the apparatus in both an anticlockwise and clockwise direction.

Typically, the process further comprises a step of cooling the solid biomass fuel after heating step (v).

Typically, the process further comprises a step (vi) of removing dust particles from the solid biomass fuel. Typically, step (vi) of removing dust particles from the solid biomass fuel comprises removing dust particles from the solid biomass fuel with a screen. Preferably, the screen has a pore size of from 2 mm to 8 mm, preferably wherein the screen has a pore size of from 2 mm to 5 mm, and more preferably wherein the screen has a pore size of from 2 mm to 3 mm.

Typically, in some instances, a drum sieve is used as a screening device to remove the dust particles from the solid biomass fuel. Preferably the drum sieve comprises a rotating drum sieve.

Typically, step (vi) of removing dust particles from the solid biomass fuel comprises subjecting the solid biomass fuel to vibration, rotation, rolling, or any combination thereof. Preferably, step (vi) of removing dust particles from the solid biomass fuel comprises using a vibrating screen, wherein the vibrating screen has a pore size of from 2 mm to 8 mm, preferably wherein the screen has a pore size of from 2 mm to 5 mm, and more preferably wherein the screen has a pore size of from 2 mm to 3 mm.

Typically, the bulk density of the solid biomass fuel as determined according to DIN EN 15103 is from 0.58 kg/l to 0.8 kg/l, preferably from 0.60 kg/l to 0.75 kg/l, and more preferably from 0.60 to 0.70 kg/L.

Typically, the mechanical durability of the solid biomass fuel as determined according to DIN EN 15210-1 is 97% or more; preferably 97.5% or more.

Preferably, the biomass composition and solid biomass fuel are as defined in any of options (i) to (vii) listed below:
(i) the biomass composition consists essentially of rice straw, tobacco straw, pepper straw, aubergine straw, cassava straw, yellow bean straw, chickpea straw, Glycine max straw, or a combination thereof; and wherein the solid biomass fuel has a bulk density of from 0.50 kg/L to 0.68 kg/L, and wherein the mechanical durability of the solid biomass fuel is 97% or higher;
(ii) the biomass composition consists essentially of palm leaves, and wherein the solid biomass fuel has a bulk density of from 0.60 kg/L to 0.70 kg/L, and wherein the mechanical durability of the solid biomass fuel is 97.5% or higher;
(iii) the biomass composition consists essentially of cashew shells, Chinese chestnut shells, pistachio shells, sunflower seed shells, walnut shells, pine nut shells, or a combination thereof, and wherein the solid biomass fuel has a bulk density of from 0.62 kg/L to 0.73 kg/L, and wherein the mechanical durability of the solid biomass fuel is 97.8% or higher;
(iv) the biomass composition consists essentially of hemp, and wherein the solid biomass fuel has a bulk density of from 0.65 kg/L to 0.68 kg/L, and wherein the mechanical durability of the solid biomass fuel is 97.5% or higher;
(v) the biomass composition consists essentially moso bamboo, hemp bamboo, arrow bamboo, or a combination thereof, and wherein the solid biomass fuel has a bulk density of from 0.62 kg/L to 0.67 kg/L, and wherein the mechanical durability of the solid biomass fuel is 97.5% or higher;
(vi) the biomass composition consists essentially of lychee shells, cinnamon (logan) shells, snake skin fruit shells, mangosteen shells, durian shells, or a combination thereof and wherein the solid biomass fuel has a bulk density of from 0.62 kg/L to 0.67 kg/L, and wherein the mechanical durability of the solid biomass fuel is 97.5% or higher;
(vii) the biomass composition consists essentially of, soybean residue, peanut residue, cassava residue, sweet potato residue, coffee bean residue, or combinations thereof, and wherein the solid biomass fuel has a bulk density of from 0.62 kg/L to 0.69 kg/L, and wherein the mechanical durability of the solid biomass fuel is 97.5% or higher;
wherein the bulk density is determined according to DIN EN 15103, and wherein the mechanical durability is determined according to DIN EN 15210-1.

Typically, (i) the total dry sulphur content of the biomass solid fuel is 0.5 wt % or less, preferably 0.45 wt % or less, and most preferably 0.40 wt % or less, wherein the total dry sulphur content is determined according to DIN EN 15289.

Typically, (ii) the total dry hydrogen content of the biomass solid fuel is 3 wt % or more, preferably from 5 wt % to 10 wt %, and more preferably from 5 wt % to 7 wt %, wherein the total dry hydrogen content is determined according to DIN EN 15104.

Typically, (iii) the total dry oxygen content of the biomass solid fuel is 20 wt % or more, preferably from 25 wt % to 42 wt %, more preferably from 28 wt % to 40 wt %, wherein the total dry oxygen content is determined according to DIN EN 15296.

Typically, (iv) the total dry carbon content of the biomass solid fuel is 40 wt % or more, preferably from 45 wt % to 65 wt %, and more preferably from 50 wt % to 60 wt %, wherein total dry carbon content is determined according to DIN EN 15104.

Typically, (v) the total dry nitrogen content of the biomass solid fuel is less than 5.0 wt %, preferably less than 3.0 wt % and more preferably less than 2.5 wt %, wherein the total dry nitrogen content is determined according to DIN EN 15104.

The solid biomass fuel may typically be as defined in any one or more of options (i) to (v) recited above. Preferably, the solid biomass fuel is as defined in all of options (i) to (v) recited above.

Typically, (vi) the chemical oxygen demand (COD) of the solid biomass fuel when immersed in water is 5000 ppm or less, preferably 4000 ppm or less, and most preferably 3200 ppm or less, wherein the chemical oxygen demand is determined according to GB/11914-89.

Typically, (vii) the fixed carbon content of the solid biomass fuel is 20 wt % or more, preferably from 25 wt % to 45 wt %, wherein the fixed carbon content is determined according to DIN EN 51734.

Typically, (viii) the ash content of the solid biomass fuel is less than 20 wt %, preferably less than 18 wt %, wherein the ash content is determined according to EN 14775 at 550° C.

Typically, (ix) the volatile matter content of the solid biomass fuel is from 35 wt % to 80 wt %, more preferably from 40 wt % to 75 wt %, wherein the volatile matter content is determined according to DIN EN 15148.

Typically, (x) the internal moisture content of the solid biomass fuel is less than 8 wt %, preferably less than 6 wt %, and more preferably less than 5 wt %, wherein the internal moisture content is determined according to DIN EN 14774.

The solid biomass fuel may typically be as defined in any one or more of options (vi) to (x) recited above. Preferably, the solid biomass fuel is as defined in all of options (vi) to (x) recited above.

Typically, the biomass solid fuel has a calorific value of from 4300 kcal/kg to 6750 kcal/kg, wherein the calorific value is determined in accordance with DIN EN 14918.

Typically, the biomass solid fuel has a base moisture content of less than 10 wt %, preferably less than 8 wt %, and most preferably less than 6 wt %, wherein the base moisture content is determined according to GB/T211-2017.

Typically, the pH of the solid biomass fuel is from 4 to 10.

Typically, the coke residue of the solid biomass fuel upon combustion is 1 to 4, preferably from 2 to 3.

Typically, the solid biomass fuel is waterproof for up to 20 days, preferably up to 30 days, and more preferably up to 40 days.

Typically, the PM1.0 emissions of the solid biomass fuel upon combustion is less than 175 mg/kg, preferably less than 150 mg/kg.

Typically, the bulk density of the molded biomass product is A, and the bulk density of the biomass solid fuel is B, and wherein B/A is 0.55 to 1, wherein the bulk density is determined in accordance with DIN EN 15103.

Typically, material derived from biomass is present in the solid biomass fuel in an amount of at least 90% by weight of the total fuel content of the solid biomass fuel.

According to a second aspect of the invention, there is provided a solid biomass fuel obtainable or obtained by a process according to the first aspect of the invention.

Preferably, the biomass composition or solid biomass fuel are as further defined above in accordance with the process of the first aspect of the invention.

According to a third aspect of the invention, there is provided a solid biomass fuel derived from a biomass composition, wherein the biomass composition comprises: rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

Preferably, the biomass composition consists essentially of rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

Preferably, the solid biomass fuel consists essentially of material derived from the biomass composition.

Preferably, the biomass composition or solid biomass fuel are as further defined above in accordance with the process of the first aspect of the invention.

According to a fourth aspect of the invention, there is provided a combustion process comprising the step of combusting a solid biomass fuel in accordance with the second or third aspects of the invention so as to produce energy.

Typically, the solid biomass composition fuel is co-fired and combusted alongside a fossil fuel such as coal.

Typically, the PM1.0 emissions of the process are less than 175 mg/kg, and preferably less than 150 mg/kg.

According to a fifth aspect of the invention, there is provided the use of a solid biomass fuel according to the second or third aspects of the invention as a fuel in a combustion process, optionally wherein the use comprises using the solid biomass fuel in a process according to the fourth aspect of the invention.

According to a sixth aspect of the invention, there is provided the use of a biomass composition to produce a solid biomass composition fuel, wherein the biomass composition comprises, consists of, or consists essentially of rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

Typically, the use comprises using the biomass composition in a process according to the first aspect of the invention, and/or wherein the solid biomass fuel is as defined in above in accordance with the second or third aspects of the invention.

According to a seventh aspect of the invention, there is provided a process for producing a solid biomass fuel, wherein the process comprises the following steps:
(i) providing a biomass composition comprising biomass particles with an average particle diameter (D50) of from 1,000 μm to 75,000 μm;
(ii) pulverising the biomass composition to provide a pulverised biomass powder with an average particle diameter (D50) of from 500 μm to 10,000 μm;
(iii) drying the pulverised biomass powder so as to provide a dried pulverised biomass powder;
(iv) molding the dried pulverised biomass powder so as to provide a molded biomass product with a compression mold with a compression ratio of less than or equal to 3.5; and more preferably less than or equal to 3 such as from 1 to 3;
(v) heating the molded biomass product to a temperature of from 110° C. to 500° C. for a time period of from 0.2 to 6 hours so as to provide a solid biomass fuel;
wherein the biomass composition comprises rice straw, tobacco straw, pepper straw, aubergine straw, cassava straw, yellow bean straw, legume straw, chick pea straw, Glycine max straw, palm leaves, cashew shells, Chinese chestnut shells, peanut shells, pistachio shells, sunflower seed shells, walnut shells, pine nut shells, hemp, moso bamboo, hemp bamboo, arrow bamboo, rice husk, lychee shells, cinnamon (logan) shells, snake skin fruit shells, mangosteen shells, durian shells, soybean residue, peanut residue, cassava residue, sweet potato residue, coffee bean residue, or combinations thereof.

Preferably, the process, solid biomass fuel and/or biomass composition are as further defined above in accordance with the process of the first aspect of the invention.

Typically, the biomass composition comprises rice straw, tobacco straw, pepper straw, aubergine straw, cassava straw, yellow bean straw, legume straw, chick pea straw, Glycine max straw, palm leaves, cashew shells, Chinese chestnut shells, peanut shells, pistachio shells, sunflower seed shells, walnut shells, pine nut shells, hemp, moso bamboo, hemp bamboo, arrow bamboo, rice husk, lychee shells, cinnamon (logan) shells, snake skin fruit shells, mangosteen shells, durian shells, soybean residue, peanut residue, cassava residue, sweet potato residue, coffee bean residue, or combinations thereof in an amount of from 50% to 100% by weight.

Preferably, the biomass composition comprises rice straw, tobacco straw, pepper straw, aubergine straw, cassava straw, yellow bean straw, legume straw, chick pea straw, Glycine max straw, palm leaves, cashew shells, Chinese chestnut shells, peanut shells, pistachio shells, sunflower seed shells, walnut shells, pine nut shells, hemp, moso bamboo, hemp bamboo, arrow bamboo, rice husk, lychee shells, cinnamon (logan) shells, snake skin fruit shells, mangosteen shells, durian shells, soybean residue, peanut residue, cassava residue, sweet potato residue, coffee bean residue, or combinations thereof in an amount of from 80% to 100% by weight.

More preferably, the biomass composition consists essentially of rice straw, tobacco straw, pepper straw, aubergine straw, cassava straw, yellow bean straw, legume straw, chick pea straw, Glycine max straw, palm leaves, cashew shells, Chinese chestnut shells, peanut shells, pistachio shells, sunflower seed shells, walnut shells, pine nut shells, hemp, moso bamboo, hemp bamboo, arrow bamboo, rice husk, lychee shells, cinnamon (logan) shells, snake skin fruit shells, mangosteen shells, durian shells, soybean residue, peanut residue, cassava residue, sweet potato residue, coffee bean residue, or combinations thereof.

Typically, the mechanical durability of the solid biomass fuel as determined according to DIN EN 15210-1 is 97% or more; preferably 97.5% or more.

Preferably, the biomass composition and solid biomass fuel are as defined in any of options (i) to (viii) listed below:
(i) the biomass composition consists essentially of rice straw, tobacco straw, pepper straw, aubergine straw, cassava straw, yellow bean straw, legume straw, chickpea straw, Glycine max straw, or a combination thereof; and wherein the solid biomass fuel has a bulk density of from 0.50 kg/L to 0.68 kg/L, and wherein the mechanical durability of the solid biomass fuel is 97% or higher;
(ii) the biomass composition consists essentially of palm leaves, and wherein the solid biomass fuel has a bulk density of from 0.60 kg/L to 0.70 kg/L, and wherein the mechanical durability of the solid biomass fuel is 97.5% or higher;
(iii) the biomass composition consists essentially of cashew shells, Chinese chestnut shells, pistachio shells, peanut shells, sunflower seed shells, walnut shells, pine nut shells, or a combination thereof, and wherein the solid biomass fuel has a bulk density of from 0.62 kg/L to 0.73 kg/L, and wherein the mechanical durability of the solid biomass fuel is 97.8% or higher;
(iv) the biomass composition consists essentially of hemp, and wherein the solid biomass fuel has a bulk density of from 0.65 kg/L to 0.68 kg/L, and wherein the mechanical durability of the solid biomass fuel is 97.5% or higher;
(v) the biomass composition consists essentially moso bamboo, hemp bamboo, arrow bamboo, or a combination thereof, and wherein the solid biomass fuel has a bulk density of from 0.62 kg/L to 0.67 kg/L, and wherein the mechanical durability of the solid biomass fuel is 97.5% or higher;
(vi) the biomass composition consists essentially of rice husk, and wherein the solid biomass fuel has a bulk density of from 0.62 kg/L to 0.67 kg/L, and wherein the mechanical durability of the solid biomass fuel is 97% or higher
(vii) the biomass composition consists essentially of lychee shells, cinnamon (logan) shells, snake skin fruit shells, mangosteen shells, durian shells, or a combination thereof and wherein the solid biomass fuel has a bulk density of from 0.62 kg/L to 0.67 kg/L, and wherein the mechanical durability of the solid biomass fuel is 97.5% or higher;
(viii) the biomass composition consists essentially of, soybean residue, peanut residue, cassava residue, sweet potato residue, coffee bean residue, or combinations thereof, and wherein the solid biomass fuel has a bulk density of from 0.62 kg/L to 0.69 kg/L, and wherein the mechanical durability of the solid biomass fuel is 97.5% or higher;
wherein the bulk density is determined according to DIN EN 15103, and wherein the mechanical durability is determined according to DIN EN 15210-1.

### BRIEF DESCRIPTION OF THE DRAWINGS

FIG. 1 shows the bulk density of various solid biomass fuels of the invention as determined by DIN EN ISO 17828.

FIG. 2 shows the mechanical durability of various solid biomass fuels of the invention, as determined by DIN EN 15210-1.

FIG. 3 shows the sulphur content of various biomass fuels of the invention, as determined by DIN EN 15289.

FIG. 4 shows the dry hydrogen content of various biomass fuels of the invention, as determined by DIN EN 15104.

FIG. 5 shows the dry oxygen content of various biomass fuels of the invention, as determined by DIN EN 15296.

FIG. 6 shows the dry carbon content of various biomass fuels of the invention, as determined by DIN EN 15104.

FIG. 7 shows the dry nitrogen content of various biomass fuels of the invention, as determined by DIN EN 15104.

FIG. 8 shows the chemical oxygen demand (COD) of various biomass fuels of the invention, as determined by GB11914-89.

FIG. 9 shows the fixed carbon content of various biomass fuels of the invention, as determined by DIN EN 51734.

FIG. 10 shows the ash content of various biomass fuels of the invention, as determined by DIN EN 14775 at 550° C.

FIG. 11 shows the internal moisture content of various biomass fuels of the invention, as determined by DIN EN 14774-2.

FIG. 12 shows the volatile matter content of various biomass fuels of the invention, as determined by DIN EN 15148.

FIG. 13 shows the PM1.0 emissions of various biomass fuels of the invention, as determined by the standard method of the German ECN testing institute.

FIG. 14 shows the calorific value of various biomass fuels of the invention, as determined by DIN EN 14918.

FIG. 15 shows the received base moisture content of various biomass fuels of the invention, as determined by GB/T 211-2017.

FIG. 16 shows the particle density of various biomass fuels of the invention, as determined by EN ISO 18847.

FIG. 17 shows the pH of various biomass fuels of the invention, as determined by GB/T7702.16-1997.

FIG. 18 shows the coke slag characteristics of various biomass fuels of the invention, as determined by GB/T212-2008.

FIG. 19 shows the total moisture content of various biomass fuels of the invention, as determined by GB/T211-2017, after soaking in water for 20 days.

FIG. 20 is a photograph of an apparatus known in the art that can be used for chipping one or more sources of biomass.

FIG. 21 is a diagram of a typical compression mold that may be used in accordance with the invention, showing the compression ratio used in the molding step.

The present inventions will now be described by way of example and with reference to the accompanying Figures in which:

### DETAILED DESCRIPTION OF THE INVENTION

### Sources of Biomass

The one or more sources of biomass present in the biomass composition can be any of those discussed above. The sources of biomass used in accordance with the invention may be produced as agricultural waste as a by-product of an agricultural operation. Alternatively, these sources of biomass may be grown specifically for the purpose of being a feedstock for the preparation of biomass solid fuels. Each of the one or more sources of biomass discussed above can be obtained or harvested by conventional methods known in the art. Many of the sources of biomass described above for use in accordance with the invention can be agricultural waste. The term “agricultural waste” as used herein typically refers to plant-based waste products that are produced as a by-product of agricultural operations. For example, agricultural waste may comprise left over plant-based products that are harvested, or unwanted components of harvested plant-based products.

The term “comprising” as used herein is used to mean that any further undefined component can be present. The term “consisting” as used herein is used to mean that no further components can be present, other than those specifically listed. The term “consisting essentially of” as used herein is used to mean that further undefined components may be present, but that those components do not materially affect the essential characteristics of the composition.

As described above, preferably, the biomass compositions are free of or only contain very low amounts of woody biomass. The terms “wood”, “woody biomass”, or “wood-like biomass” as used herein, are typically used to refer to the hard fibrous substance consisting basically of xylem that makes up the greater part of the stems, branches, and roots of trees or shrubs beneath the bark. Wood is only found to a limited extent in herbaceous plants. This definition of the term “wood” is in line with the commonly understood definition in the art.

Unlike wood-like sources of biomass used in certain prior known processes for producing solid biomass fuel, the one or more sources of biomass used in the present invention can be grown and harvested on a commercial scale, providing increased control of the quality and specific characteristics of the biomass sources compared to the wood-like materials used in the prior art. Use of said biomass sources also avoids the environmental damage associated with using trees such as necessary deforestation. Use of the one or more sources of biomass used in the present invention has also surprisingly been found to be easier to grind than said prior used wood-like materials. This reduces the costs of the grinding process. Use of the materials for use in the invention, when ground, also provides a more homogenous mix of particle sizes than said prior used wood-like materials. Without being limited by theory, this is believed to impart advantageous properties to the final solid fuel product, such as greater uniformity and continuousness of the biomass fuel products. This is desirable in combustion processes for a number of reasons.

As discussed above, use of the source materials described above has surprisingly been found to provide solid biomass fuels with surprisingly high mechanical durabilities of 97% or higher when formed into solid biomass fuels using the process steps of the present invention.

### Providing the Biomass Composition

The process comprises step (i) of providing a biomass composition comprising biomass particles with an average particle diameter (D50) of from 1,000 μm to 75,000 μm. Preferably, the biomass composition comprises biomass particles with an average particle diameter (D50) of from 1,000 μm to 60,000 μm. For example, in some instances, the biomass composition comprises biomass particles with an average particle diameter (D50) of from 30,000 μm to 60,000 μm such as an average particle diameter of from 40,000 μm to 50,000 μm.

The biomass composition may be provided as particles with a size in the above range by introducing one or more sources of biomass into a conventional chipping apparatus, although this will of course be dependent upon the specific source of biomass. For example, if the source of biomass occurs naturally with particles having sizes in the above range, then chipping will not be necessary. Accordingly, the process of the invention may comprise chopping one or more sources of biomass so as to provide a biomass composition comprising biomass particles having an average particle diameter (D50) of from 1,000 μm to 75,000 μm, or any of the other size ranges described above.

The step of providing the biomass composition with an average particle diameter (D50) of from 1,000 μm to 75,000 μm may comprise harvesting the one or more sources of biomass with a conventional combine. The combining process involves chopping and breaking up the biomass into particles of the desired size.

The step of providing the biomass composition may additionally comprise reducing the water content of the biomass to less than 50% by weight. Such a step may comprise compressing the biomass composition. This compression step typically squeezes moisture from the biomass composition such that the moisture content of the biomass composition is reduced to less than 50% by weight. Accordingly, in some instances, the step of providing a biomass composition with a particle size as discussed above comprises compressing a biomass composition with a moisture content of more than 70% by weight such that after compression, the moisture content of the biomass composition is less than 50% by weight.

The step of providing a biomass composition with a particle size as discussed above may comprise both a step of compressing the biomass and also a step of chopping the biomass.

The chopping step and compression step (if included) may be carried out using separate apparatus. Alternatively, the steps may be carried out in a single apparatus configured for both chipping and compressing the biomass. For example, a motorised rolling device suitable for compressing biomass may be placed on a conveyor belt that feeds a conventional chipping device. In this respect, the biomass source is compressed before it enters the chipper. Apparatus suitable for carrying out compression and chipping steps of the one or more sources of biomass are known in the art.

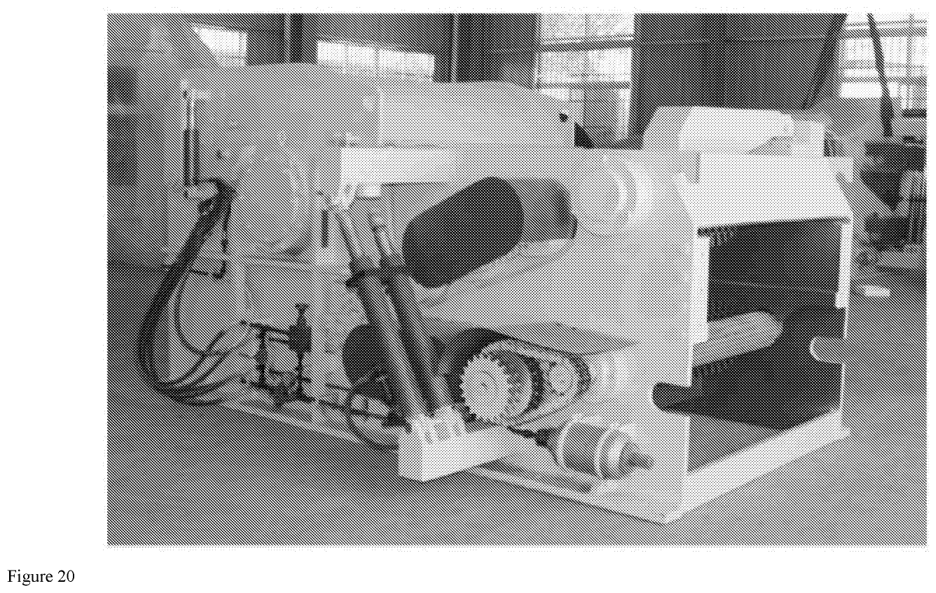

An example of an apparatus used for chipping is shown in FIG. 20. Chipping apparatus such as those shown in FIG. 20 typically work on the principle of material entering the chipper via a conveying system such as conveyor belt that feeds material through a feeding port. The material is then cut into chips by a high-speed rotating blade (not shown) and a blade mounted on the base of the machine (not shown). The functioning of said mechanism and of similar chipping mechanisms are known to the person skilled in the art.

Preferably, the step of providing the biomass composition does not comprise compressing the biomass composition, and/or does not comprise reducing the moisture content of the biomass composition.

### Pulverisation of Biomass

Step (ii) comprises pulverising the biomass composition to provide a pulverised biomass powder with an average particle diameter (D50) of from 500 μm to 10,000 μm.

The biomass composition may be pulverised into a biomass powder by standard techniques known in the art. The biomass composition may be pulverised such that the biomass powder has an average particle diameter (D50) of from 500 μm to 10,000 μm. Preferably, the biomass composition is pulverised to have an average particle diameter of from 1000 μm to 8,000 μm, and more preferably from 1,000 to 5000 μm. As discussed above, pulverising the specific biomass sources for use in the present invention has been found to provide a biomass powder with an advantageous smaller particle size distribution than provided by grinding prior known wood-like biomass sources.

It has further been found that the smaller the particles of pulverised biomass powder, the greater the quality and performance characteristics of the biomass solid fuel product. Without being limited by theory, this is believed to be due to greater uniformity and homogeneity of the final solid biomass fuel product. Smaller powder particle size and greater uniformity and homogeneity of the final fuel product is believed to be linked to improved performance characteristics of the fuel upon combustion, and also to improved water-proof characteristics of the solid fuel product.

Prior to pulverisation, the biomass composition typically comprise less than 50% by weight of moisture.

Different pulverisation processes are preferred for different sources of biomass with different moisture contents. For example, when the moisture content of the biomass composition is 20% by weight or less, preferably, the step of pulverising the biomass involves the use of a negative pressure pneumatic conveyancing apparatus. Such negative pressure pneumatic conveyancing apparatus are known in the art.

When the moisture content of the biomass composition is 20% by weight or greater, the biomass composition may be directly pulverised without the use of a negative pressure pneumatic conveyancing apparatus.

The average particle diameter (D50) of the biomass particles discussed above in the context of steps (i) and (ii) of the process of the invention may be determined using techniques known in the art to the skilled person. For example, standard tests ISO 17827-1 and/or ISO 17827-2 may be used to calculate the D50 of the biomass particles.

### Drying the Pulverised Biomass Powder

The biomass is dried in step (iii) of the process. Step (iii) of drying the pulverised biomass powder so as to provide a dried pulverised biomass powder typically comprises drying the pulverised biomass powder such that the dried pulverised biomass powder has a moisture content of from 10% by weight to 18% by weight, preferably from 12% by weight to 15% by weight. However, it will be appreciated that it is not essential that the dried pulverised biomass powder has a moisture content within this range.

The step of drying the biomass powder may also comprise mixing the pulverised biomass powder. If one source of biomass is used in the process, this single source of biomass may be mixed. Alternatively, if more than one source of biomass is used in the process, the drying step may involve mixing the pulverised biomass powder with one or more additional sources of biomass. For example, where the solid biomass fuels are formed from at least two sources of biomass, whilst the two or more sources of biomass can be mixed during any step of the process of the invention, preferably the sources of biomass are mixed during the drying step of the process of the invention. The pulverised biomass powder may thus be mixed with an additional source of biomass that is also a pulverised biomass powder prepared using the process steps described herein. Alternatively, the one or more additional sources of biomass mixed with the pulverised biomass powder during the drying step are not processed as described herein. For example, the pulverised biomass powder prepared as described herein may be mixed with one or more additional sources of biomass that are prepared in different ways.

The pulverised biomass powder may be dried using any suitable method, such as using standard drying cylinders known in the art. For example, the drying step may be carried out in a drying apparatus that comprises a rotating drying drum. The rotation of the rotating drying drum can be used to mix the pulverised biomass powder with one or more additional sources of biomass as described above. Typically, the rotating drying drum comprises a lifting plate. The lifting plate continuously raises material while the drying cylinder rotates. It has been found by the inventors of the present invention that the use of a rotating drying cylinder with a lifting plate results in improved mixing of the one or more biomass powders where the one or more biomass powders are being dried with additional materials, or where two or more biomass powders are being mixed.

Where the pulverised biomass powder has a moisture content of less than 20 wt %, typically, the pulverised biomass powder is dried in a single drying cylinder. Accordingly, in these instances, the process of the invention comprises drying the pulverised biomass powder in a only one single drying cylinder.

Where the pulverised biomass powder has a moisture content of greater than 20 wt %, the pulverised biomass powder is typically dried in multiple drying cylinders. Accordingly, in these instances, the process of the invention comprises drying the pulverised biomass powder in more than one drying cylinder. For example, the process may comprise drying the pulverised biomass powder in two or more, three or more, four or more, or five or more drying cylinders.

### Molding the Dried Pulverised Biomass Powder

The dried pulverised biomass powder is molded so as to provide a molded biomass product. The molding step may be carried out in any molding apparatus known in the art and in accordance with biomass molding techniques known in the art, and may include extrusion systems. Preferably, the molding step is carried out in a compression mold. Preferably, the compression mold comprises a mold product exit hole. The molding step may be carried out using an apparatus as described in CN105435708.

Preferably, the molding step comprises molding the dried pulverised biomass powder into pellets. Accordingly, preferably, the molded biomass product and solid biomass fuel product comprises biomass pellets.

Whilst it is known to mold biomass powder to produce molded biomass products, the inventors of the present invention have found that adapting the molding step such that the density of the molded biomass product produced from said step is controlled so as to be within a certain range imparts certain advantageous properties to the final solid biomass fuel product. Specifically, controlling the molding step such that the density of the molded biomass product is within the range of from 1.0 to 1.35 kg/L has been found to impart advantageous properties to the final biomass fuel product. Preferably, the molding step is controlled such that the density of the molded biomass product is from 1.0 kg/L to 1.35 kg/L. Typically, the above mentioned densities are determined according to NY/T 1881.7-2010. Accordingly, preferably, the molding step is controlled such that the density of the molded biomass product is from 1.0 kg/L to 1.35 kg/L, wherein the density is determined according to NY/T 1881.7-2010.

The molding step may be controlled in a variety of ways. Where the molding process comprises the use of a compression mold, the density is typically controlled by using a compression ratio of less than 8, such as less than 7, less than 6, less than 5, or less than 4. Preferably, a compression ratio of less than or equal to 3.5 is used, more preferably less than or equal to 3, and most preferably from 1 to 3.

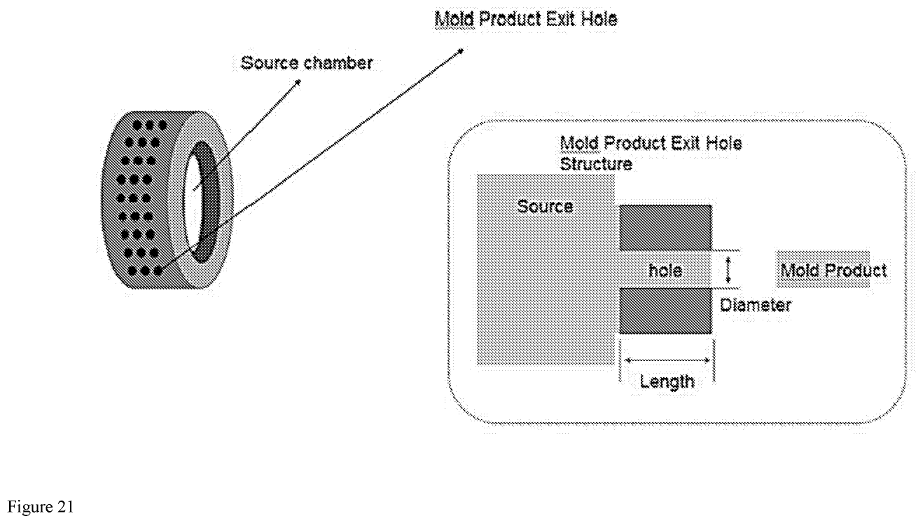

The compression ratio for a compression mold with a mold product exit hole may be defined as the ratio of the length to the diameter of the mold product exit hole. FIG. 21 shows an example of a compression mold that may be used in accordance with the present invention. The dried pulverised biomass powder is inserted into the interior of the mold before being squeezed from inside the mold by pressure such that it exits the mold product exit hole in the Figure. The compression ratio is shown in the Figure as the ratio of the length of the product out hole to its diameter.

Typically, the smaller the compression ratio, the lower the density of the molded biomass product. It is desirable for the density of the molded biomass product to be higher, such as within the abovementioned range, as this is believed by the inventors to be associated with high durability of the final solid biomass fuel product, along with increased bulk density, increased water-proof capacity and increased uniformity of the solid fuel product. Accordingly, higher compression ratios are often desirable in order to provide a final solid biomass fuel product with the desired properties. However, the higher the compression ratio, the lower the yield of the molded biomass product. Higher compression ratios also typically increase the costs of a process due to the higher pressures involved to mold the biomass. Accordingly, there is a balance to be struck between high enough compression ratios to provide desired fuel properties but without the ratio being too high that the process yield is reduced or process cost increased. In processes known in the art for making solid biomass fuels from non-wood sources of biomass such as those taught in WO2020/229824, WO2021/014151, WO2021/024001 and WO2021/156628, typically a compression ratio of from 3.8 to 6.5 has been found important for providing solid biomass fuels with the properties discussed above. If compression ratios of less than 3.8 are used then the fuels do not have the desired high performance properties discussed above. In contrast, it has surprisingly been found by the inventors of the present invention that the specific biomass sources discussed above, when formed into solid fuels using the process of the invention, have desirable high performance properties where a compression ratio of less than 3.5 is used in the molding step, as discussed above. This is highly advantageous as the use of a lower compression ratio means that process costs can be reduced and that the yield of the process is increased. Even more surprisingly, it has been found that even when using lower compression ratios of less than 3.5, with the source materials and process steps of the present invention, the mechanical durability of the solid biomass fuel is even higher than the durability of the fuels taught in the prior art, despite the fact that the prior art processes involve the use of higher compression ratios.

In the process of the invention, preferably, the step (iv) of molding the dried pulverised biomass powder comprises adapting the molding step such that that density of the molded biomass product is controlled to be within the range of from 1.1 kg/L to 1.35 kg/L, typically wherein the density is determined according to NY/T 1881.7-2010. Preferably, the density is controlled by using a compression mold and controlling the compression ratio of the compression mold. More preferably, the compression ratio is less than or equal 3.5 as discussed above.

Controlling the density of the molded biomass product during the molding step has been found, surprisingly, to provide a final biomass fuel product with good water proof capacity. Preferably, the solid biomass fuel product produced from a molded biomass product with a density within the range of from 1.1 kg/L to 1.35 kg/L is sufficiently water proof for up to 20 days, and preferably up to 30 days.

Preferably, an additive is added to the dried pulverised biomass powder prior to step (iv) of molding the dried pulverised biomass powder. Said additive is believed to improve the molding process and increase the yield of the molded biomass product produced from the molding step. Suitable additives are known in the art and include, but are not limited to starch, or starch derivatives.

Typically, other than additives such as those discussed above, no other fuel source is added to the dried pulverised biomass powder during the molding step. Accordingly, the molded biomass product of the molding step typically comprises only material derived from biomass as the fuel source in the solid biomass fuel. For example, when the dried pulverised biomass powder is molded into pellets, typically, no other fuel source is added to the dried pulverised biomass products prior to molding such that the solid biomass fuel pellets produced at the end of the process only contain a fuel source derived from biomass. Preferably, the solid biomass fuel thus comprises at least 50% by weight of the total fuel content of the fuel, such as at least 60% by weight, at least 70% by weight, at least 80% by weight, at least 90% by weight and preferably at least 95% by weight of material derived from biomass.

Where the term total fuel content of the solid fuel is used herein, this is intended to refer to the component of the solid fuel that is combustible material such as biomass derived material and coal. The term fuel content in relation to solid fuel is not intended to encompass additives that may be present in the solid fuel pellets that do not themselves combust to produce energy.

The molding step has also been found to enhance the waterproof properties of the final biomass solid fuel product. The increase in density that occurs during the molding step means that it is harder for water to penetrate the denser molded biomass product particles.

Furthermore, with a denser product, more biomass is concentrated in the interior of the molded product, and so is not in direct contact with water.

### Heating the Molded Biomass Product

The molded biomass product is heated so as to produce a solid biomass fuel. The heating is carried out at a temperature of from 110° C. to 500° C. for a time period of from 0.2 to 6 hours. Preferably, the step of heating the molded biomass product is carried out for a time period of from 0.3 to 2.5 hours. Preferably, the step of heating the molded biomass product comprises heating the molded biomass product to a temperature of from 220° C. to 350° C., and more preferably to a temperature of from 220° C. to 320° C.

Preferably, the step (v) of heating the molded biomass product comprises heating the molded biomass product under conditions so as to induce torrefaction of the molded biomass product. Torrefaction is a process of mild pyrolysis in which the heating is carried out in a low oxygen atmosphere such as an atmosphere of less than 10% oxygen content. Suitable conditions and processes of torrefaction are known in the art. Accordingly, preferably step (v) of heating the molded biomass product comprises torrefaction.

The heating step may be carried out in any suitable apparatus known in the art for heating the molded biomass product. For example, the heating step may be carried out in apparatus and using process conditions as disclosed in EP3287509A1.

Preferably, step (v) of heating the molded biomass product is adapted so as to control the uniformity of the solid biomass fuel, optionally wherein adapting step (v) so as to control the uniformity of the solid biomass fuel comprises conducting step (v) in an apparatus in which the molded biomass product is rotated whilst being heated, optionally, wherein adapting step (v) so as to control the uniformity of the solid biomass fuel comprises controlling the speed or direction of rotation of the molded biomass product, optionally wherein the molded biomass product is rotated in the apparatus in both an anticlockwise and clockwise direction. The uniformity of the solid biomass fuel is also optimised by the heating temperatures and time periods discussed above.

The process of the invention may comprise a step of cooling the solid biomass fuel after heating. Where the process of the invention comprises a cooling step after the step of heating the biomass, the cooling step may comprise rotating the solid biomass fuel. The biomass may be rotated in a suitable apparatus such as those disclosed in EP3287509A1. Preferably, both heating step (v) and the step of cooling the biomass comprise rotating the biomass. Where the biomass is rotated in either the cooling step or the heating step, the biomass may be rotated in different directions, such as both clockwise and anti-clockwise in successive cycles.

The term ‘uniformity’ of the solid biomass product is used to refer to the solid biomass fuel or molded biomass product having constant or similar properties across each particle of solid biomass fuel or molded biomass product and across the plurality of particles within a bulk sample of the solid biomass fuel product or molded biomass product. For example, but not limited to, the densities of the particles, the ease of combustion of the particles, the chemical composition of the particles, and the water resistant properties of the particles. Uniformity is a highly desirable property for biomass fuels for use in combustion processes.

It has also been found by the inventors that controlling the heating step in the manner discussed above additionally aids in providing a solid biomass fuel product with enhanced water proof properties. During the heating step, hydrophilic compounds present in the biomass powders that absorb water are degraded. Furthermore, the heating step causes oils present in the biomass powders to migrate to the exterior of the biomass powder particles, increasing the hydrophobicity of said particles.

Removing Dust Particles from the Solid Biomass Fuel

The process of the invention may comprise step of removing dust particles from the solid biomass fuel. It has been found by the inventors of the present invention that in biomass solid fuel production processes known in the art, significant quantities of dust adheres to the solid biomass fuel. This dust is problematic because it may pollute the air during transport and packaging of the solid biomass fuel. The dust may also pollute the local environment. Furthermore, when stored in the open air, dust particles form mildew and affect the performance and quality of the solid biomass fuel. Thus, it would be beneficial for dust on the surfaces of the particles of the solid biomass fuel to be removed.

The inventors have found that the dust on the surface of the biomass solid fuel particles may be removed by inducing friction between the particles. For example, dust that is adhered to the particles may be removed by inducing friction by means such as vibrating or rotating the solid biomass fuel particles. Accordingly, a step (vi) of removing dust from the solid biomass particles may comprise inducing friction between the particles of solid biomass fuel. For example, step (vi) of removing dust from the solid biomass particles may comprise subjecting the particles to vibration, rotation, rolling, or any combination thereof. Suitable apparatus for conducting rolling, rotation, and vibration of the solid biomass fuel particles are known to the person skilled in the art, and are shown in FIGS. 25 and 26. An example of an apparatus that may be used to remove dust from the particles is a rotating drum sieve.

Step (vi) of removing dust particles from the solid biomass fuel may comprise removing dust particles from the solid biomass fuel with a screen. Typically, the screen has a pore size of from 2 mm to 10 mm, preferably 2 mm to 8 mm, more preferably from 2 mm to 5 mm, and most preferably from 2 mm to 3 mm. Dust particles that are admixed with the solid biomass fuel particles may be separated from the solid biomass fuel by passing through the screen. The larger solid biomass fuel particles do not pass through the screen and are thus separated from the dust particles. Suitable apparatus and methods for performing the screening step are known to those skilled in the art, and any of said suitable apparatus may be used. For example, an apparatus that employs screening, rolling and rotating the solid biomass fuel may be used to remove dust particles from the solid biomass fuel. In the use of such a device, solid biomass fuel may be laid upon a screen, and the screen may be driven to roll and rotate upon its axis by operation of a motor. During rolling/tilting and rotation of the screen, material on the sieve surface of the screen is turned over. Some material passes through the screen and is separated from material that does not pass through the screen. The rolling and rotation of the screen causes material stuck in the pores of the screen to fall through and thus clogging of the pores of the screen is prevented. Alternatively, an apparatus that vibrates and screens the solid biomass fuel particles may be used. In this case, a motor can be used to vibrate the screen which may cause material to be thrown up on the screen surface. This process may cause small particles adhered to larger ones to come loose and then pass through the pores in the screen. An example of an apparatus that employs a screen and vibration to separate larger particles from smaller particles, where the smaller particles may or may not be adhered to the larger particles is a device as taught in CN201324717.

Accordingly, methods of the invention may comprise subjecting the solid biomass fuel particles to one or more of rolling, rotation and vibration so as to induce friction between the solid biomass fuel particles which causes dust particles adhered to said solid biomass fuel particles to be removed from said particles. The methods then preferably comprise subjecting the mixture of solid biomass fuel particles and dust particles to a screening step as discussed above to remove said dust particles from said solid biomass fuel particles. Accordingly, removal step (vi) is an effective post-treatment for removing dust from said particles of solid biomass fuel.

### The Biomass Solid Fuel

The solid biomass fuel product may have any of the physical properties discussed above.

As discussed above, the biomass solid fuel of the invention preferably comprises pellets. The pellets may be any suitable size. Preferably, the pellets have a diameter of from 3 mm to 100 mm, and more preferably, 5 mm to 8 mm. Preferably, the pellets have a length of from 20 mm to 60 mm, and more preferably from 30 mm to 50 mm. As discussed above, surprisingly, it has been found that the solid biomass fuel product of the invention has enhanced waterproof characteristics compared to solid biomass fuel products made by prior art processes. This is believed to be due to controlling the pulverising, molding and/or heating step as discussed above. Biomass fuels of the invention are sufficiently water proof up to 20 days, preferably 30 days and more preferably 40 days.

The water proof properties of the solid biomass fuels may be determined according to standard tests of the Energy Research Centre of the Netherlands (ECN).

The moisture content of the biomass composition solid fuel of the invention may also be determined by standard ECN test methods. The internal moisture content of the solid biomass composition fuel of the invention is typically less than 8 wt %, preferably less than 6 wt %, and more preferably less than 5 wt %, wherein the internal moisture content is determined according to DIN EN 14774.

The biomass composition solid fuel has a base moisture content of typically less than 10 wt %, preferably less than 8 wt %, and most preferably less than 6 wt %, wherein the base moisture content is determined according to GB/T211-2017.

The solid biomass composition fuel of the invention has also been found to have unexpectedly high mechanical durability. The mechanical durability is typically higher than 97%, and preferably higher than 97.5%. This is advantageous since biomass pellets with such mechanical durability or greater have been found to be able to stored outside without damage for periods as long as two months. In contrast, biomass pellets with lower mechanical durability typically are damaged by rainfall and are not able to be stored outside. Accordingly, high mechanical durability is an additional advantage of biomass pellets of the invention. As discussed above, the biomass solid fuels of the invention have been to have particularly high mechanical durability.

An additional advantage associated with high durability of the solid biomass fuel particles is that if the pellets are somehow broken by force, they fall apart in larger pieces than pellets with low mechanical durability. This minimises any dust explosion risks.

As discussed above, in preferable instances, typically, other than additives such as those discussed above, no other fuel source is added to the heated biomass composition product during the molding step. Accordingly, the solid biomass composition fuel typically comprises only material derived from biomass as the fuel source in the solid biomass fuel. For example, when the heated biomass composition product is molded into pellets, typically, no other fuel source is added to the heated biomass composition products prior to molding such that the solid biomass composition fuel pellets produced by the molding step only contain a fuel source derived from biomass.

Preferably, the solid biomass fuel thus comprises at least 50% by weight of the total fuel content of the fuel, such as at least 60% by weight, at least 70% by weight, at least 80% by weight, at least 90% by weight and preferably at least 95% by weight of material derived from biomass.

The solid biomass composition fuel preferably comprises material derived from biomass in an amount of at least 75% by weight; preferably at least 80% by weight and more preferably at least 90% by weight. More preferably, the solid biomass fuel comprises material derived from rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof, in an amount of at least 75% by weight; preferably at least 80% by weight and more preferably at least 90% by weight.

Most preferably, the solid biomass fuel consists essentially of or consists of material derived from rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

### Examples

The process of the present invention was carried out using various biomass sources as components of the biomass composition. The molding step involved the use of a compression mold with a compression ratio of 3. The heating step involved heating to a temperature of 320° C. for a time period of 1.8 hours.

The biomass source materials used are detailed in Table 1 below. Examples A to F; H and I are examples of the invention. Examples G, J and K are reference examples.

TABLE 1

| Example | Source material |
|---|---|
| A | Tobacco straw |
| B | Palm leaves |
| C | Cashew shells |
| D | Hemp (flax) |
| E | Arrow bamboo |
| F | Rice husk |
| G | Reference example |
| H | Lychee shells |
| I | Peanut residue |
| J | Reference example |
| K | Reference example |

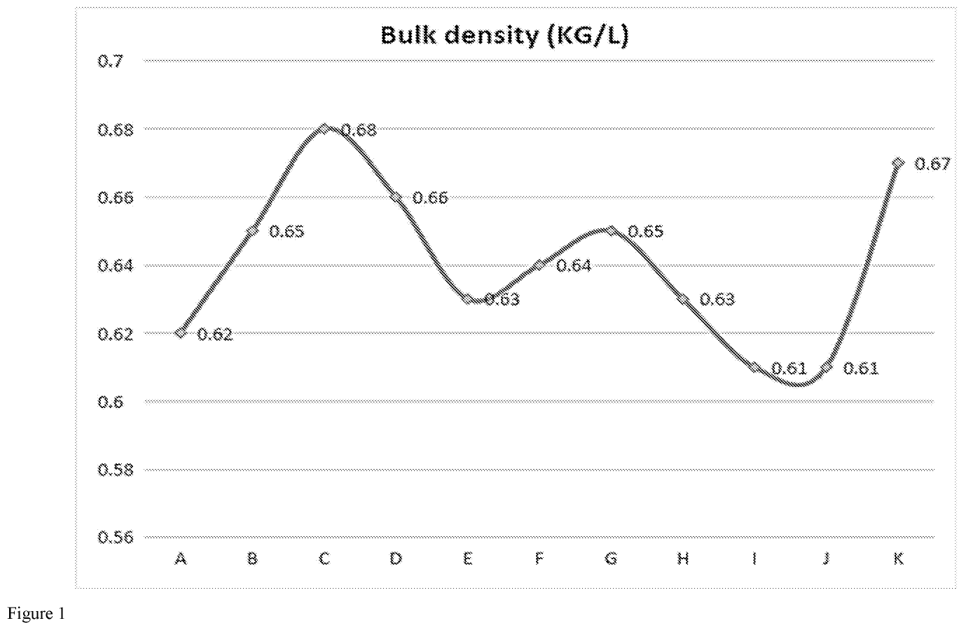

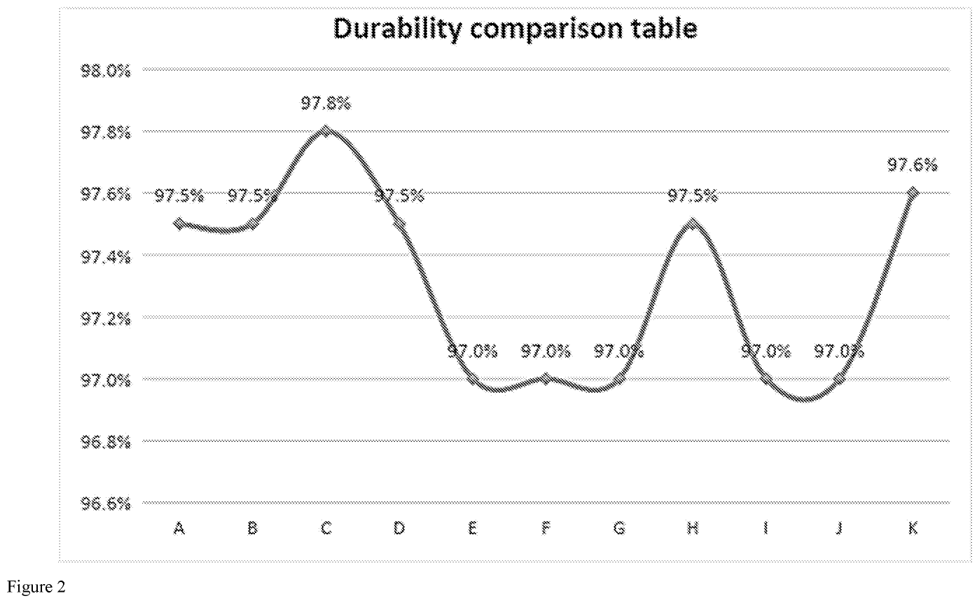

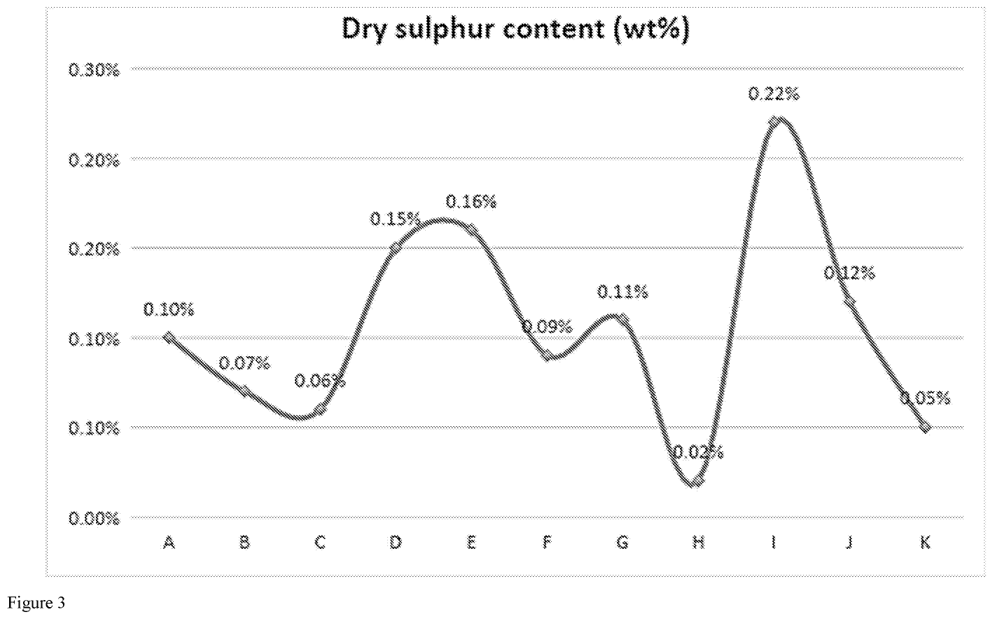

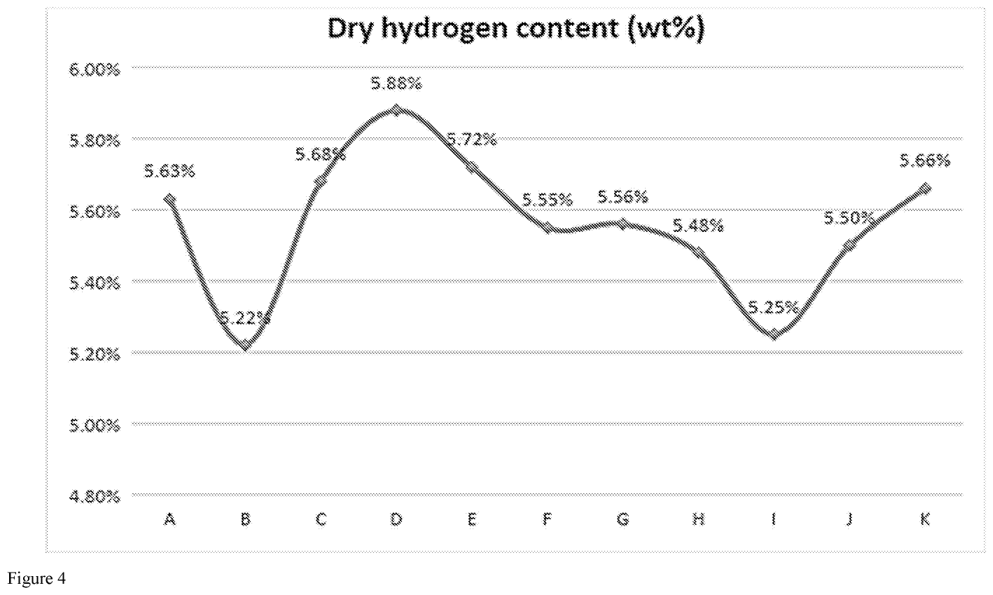

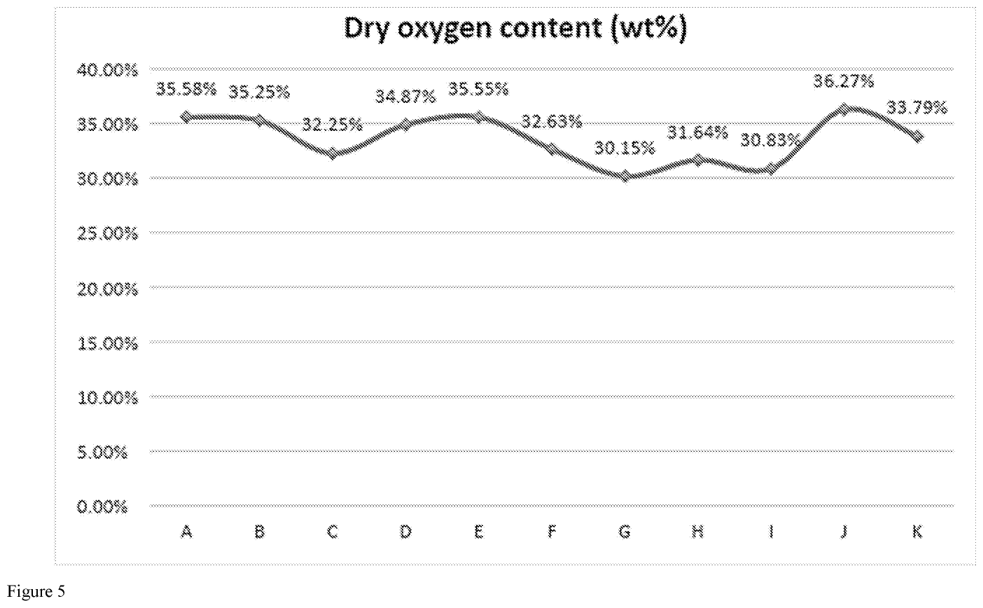

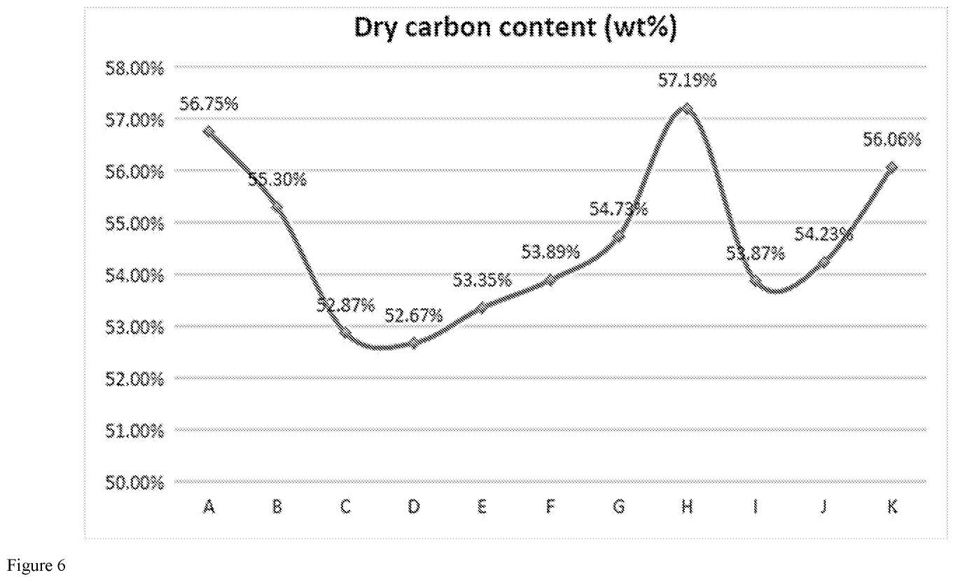

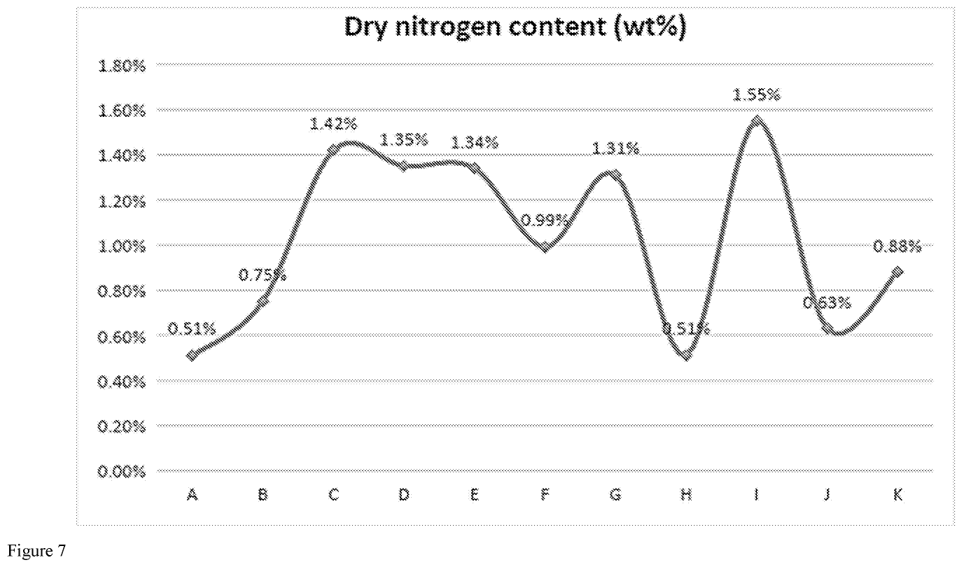

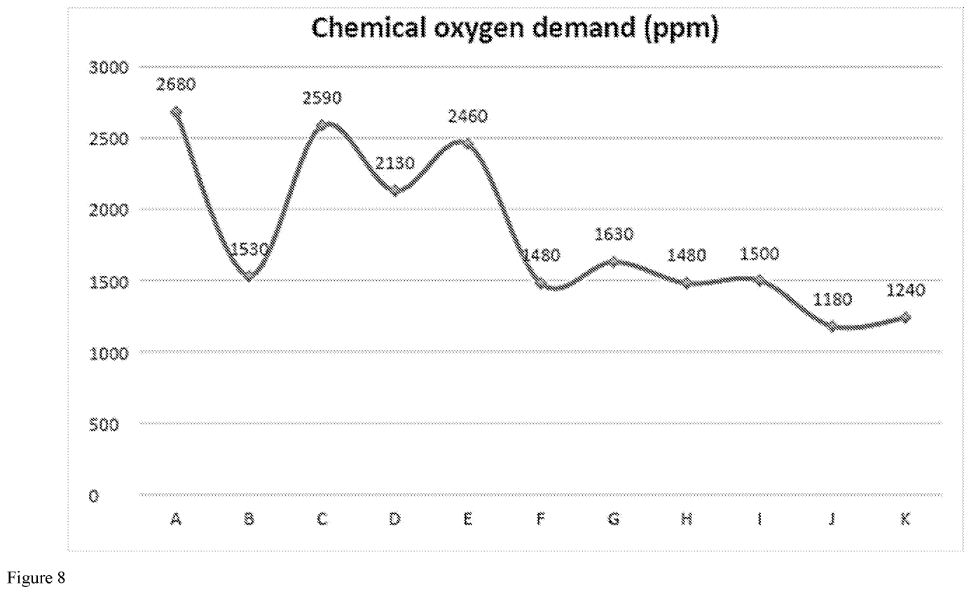

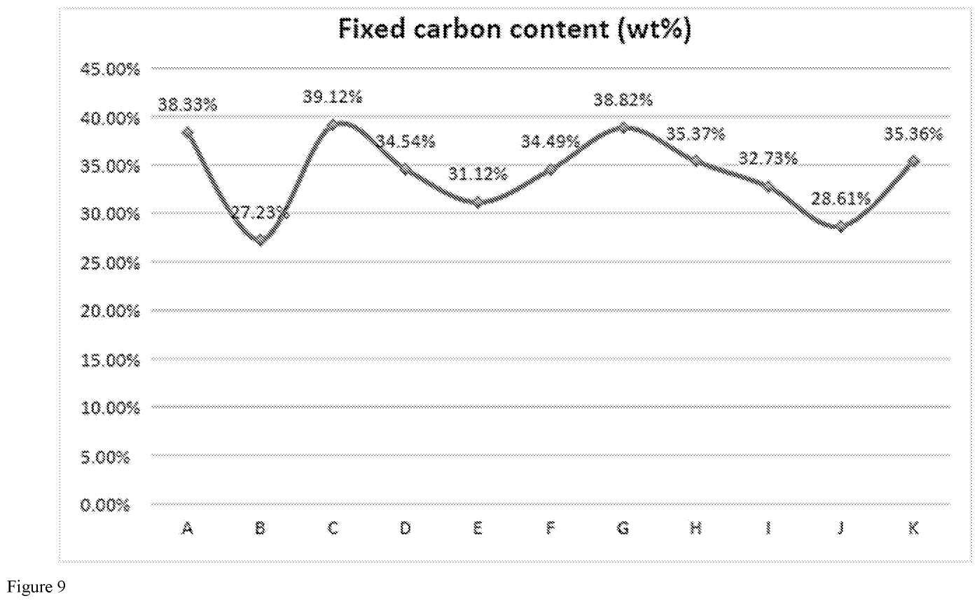

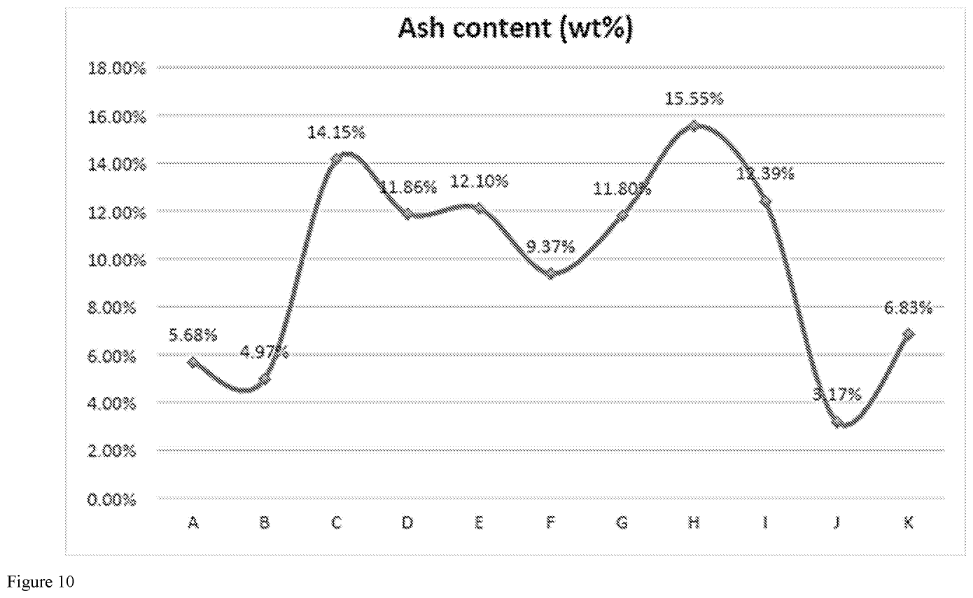

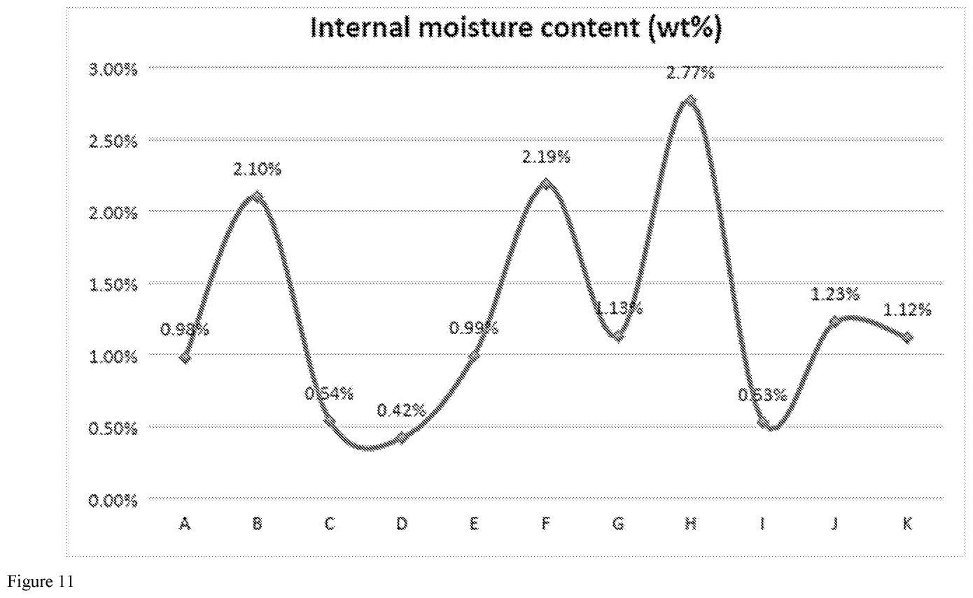

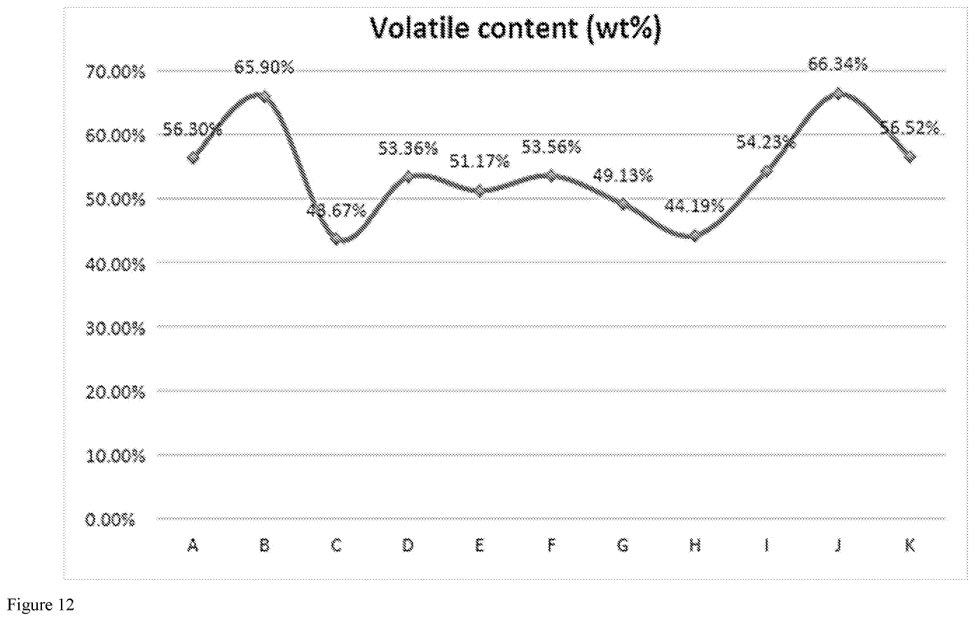

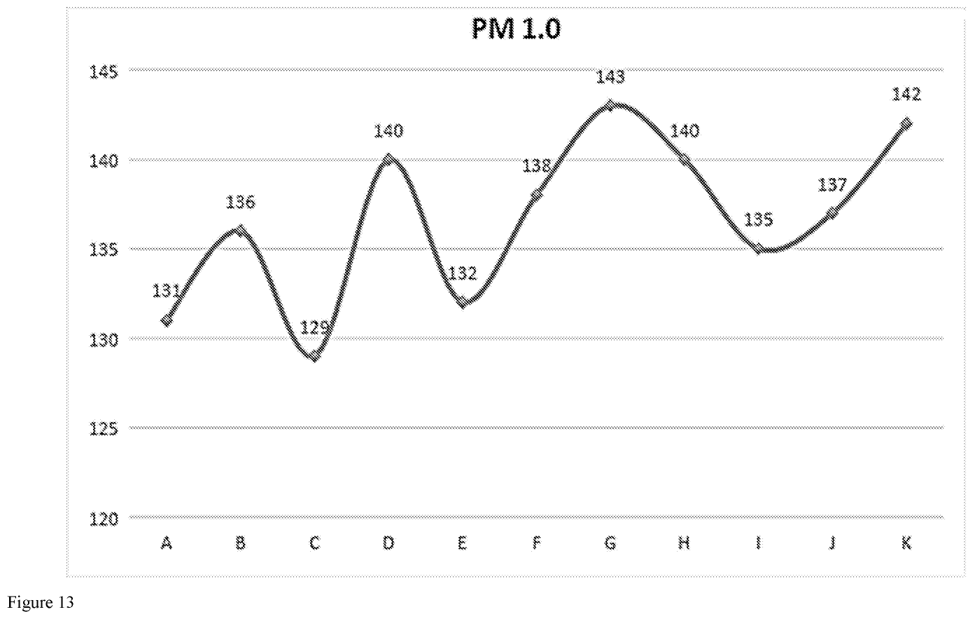

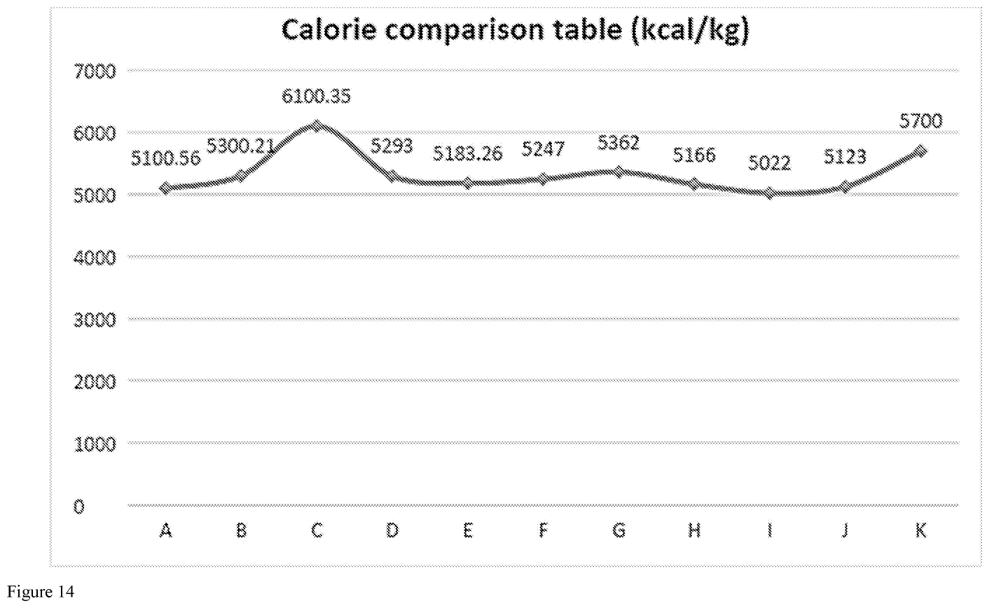

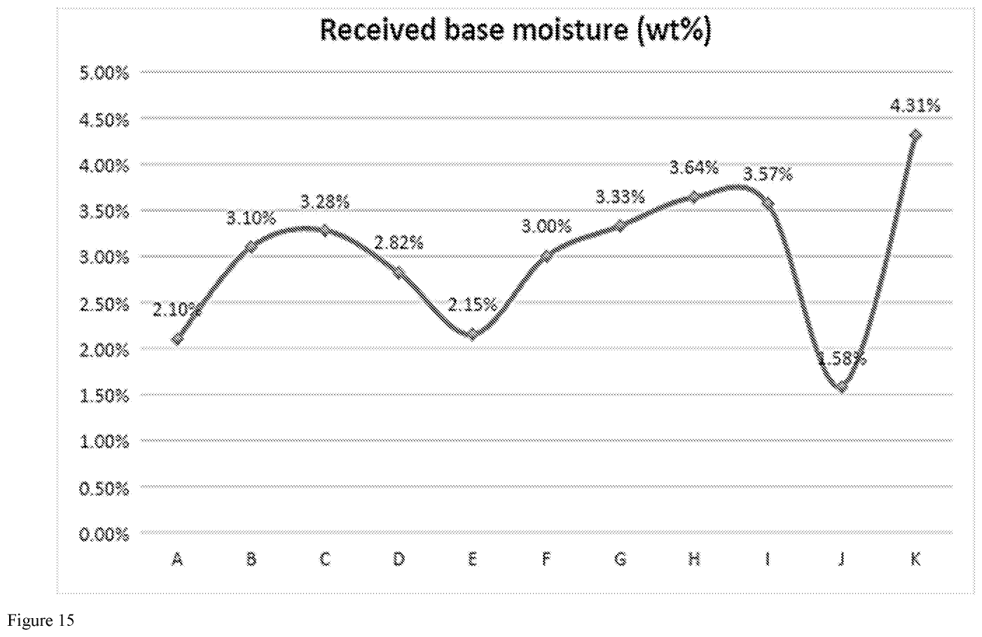

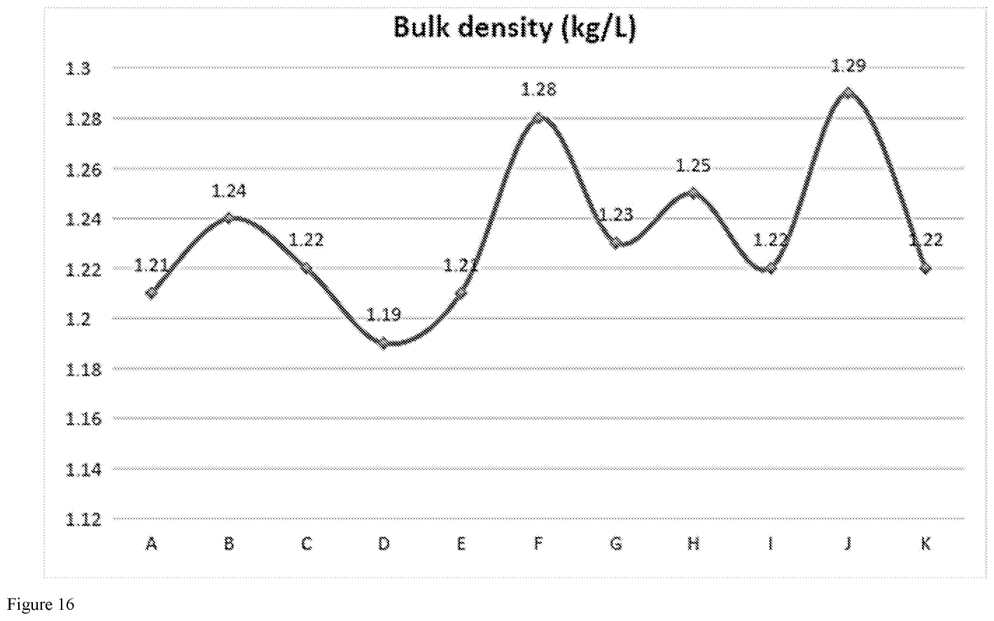

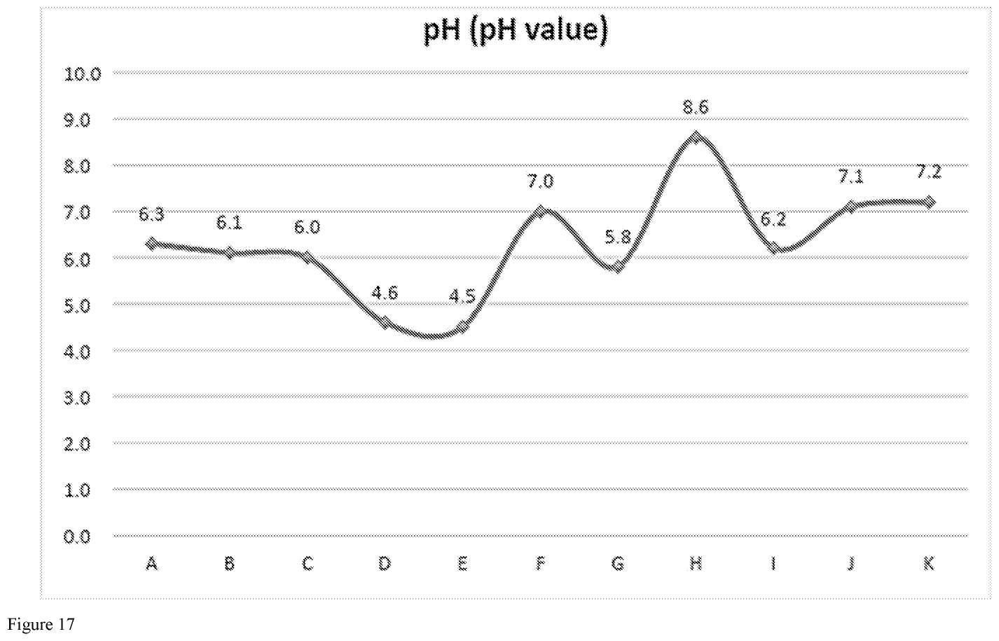

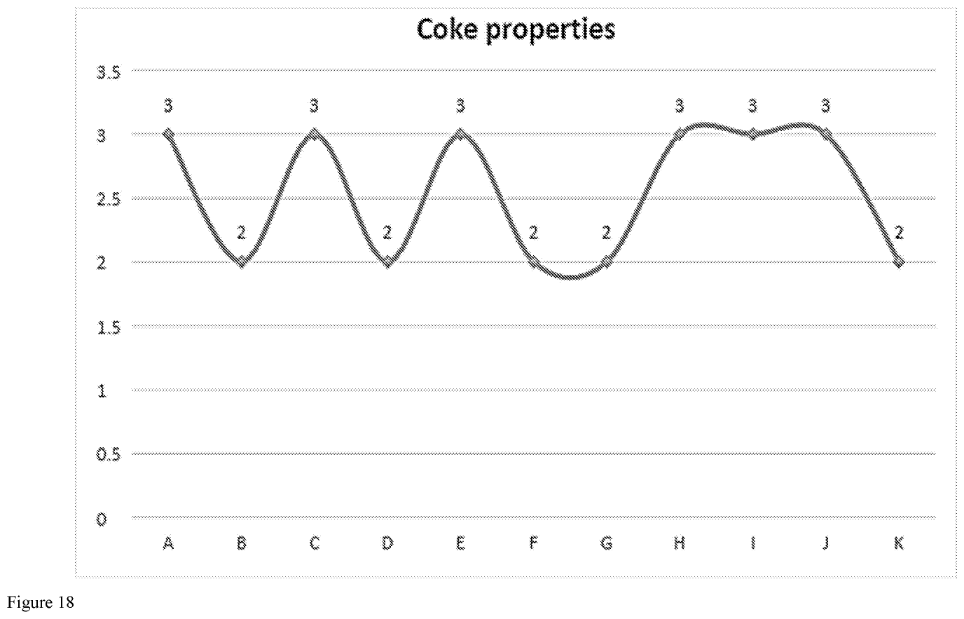

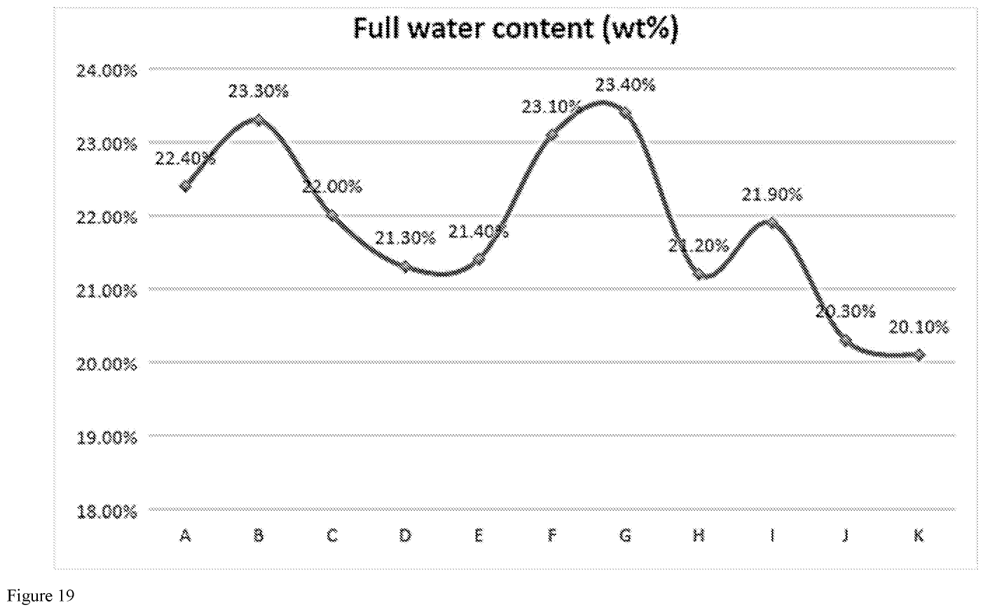

The properties of the solid biomass fuels produced in the examples are depicted in FIGS. 1 to 19. It can be seen that the solid biomass fuels of the invention have comparative properties to fuels disclosed in prior art documents WO2020/229824, WO2021/014151, WO2021/024001 and WO2021/156628, with the exception of the mechanical durability which is higher for solid biomass fuels of the invention. As can be seen, the mechanical durabilities are all 97% or higher.

1. A process for producing a solid biomass fuel, wherein the process comprises the following steps:
(i) providing a biomass composition comprising biomass particles with an average particle diameter (D50) of from 1,000 μm to 75,000 μm;
(ii) pulverising the biomass composition to provide a pulverised biomass powder with an average particle diameter (D50) of from 500 μm to 10,000 μm;
(iii) drying the pulverised biomass powder so as to provide a dried pulverised biomass powder;
(iv) molding the dried pulverised biomass powder so as to provide a molded biomass product;
(v) heating the molded biomass product to a temperature of from 110° C. to 500° C. for a time period of from 0.2 to 6 hours so as to provide a solid biomass fuel;
wherein the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

2. A process according to claim 1, wherein the biomass composition comprises hemp selected from ramie, jute, green flax, flax, rooibos, kenaf, or combinations thereof.

3. A process according to claim 1 or claim 2, wherein the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof in an amount of from 50% to 100% by weight.

4. A process according to any preceding claim, wherein the biomass composition comprises rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof in an amount of from 80% to 100% by weight.

5. A process according to any preceding claim, wherein the biomass composition consists essentially of rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

6. A process according to any preceding claim, wherein the solid biomass fuel comprises material derived from the biomass composition in an amount of at least 75% by weight; preferably at least 80% by weight.

7. A process according to any preceding claim, wherein the solid biomass fuel comprises material derived from the biomass composition in an amount of at least 90% by weight.

8. A process according to any preceding claim, wherein the solid biomass fuel consists essentially of or consists of material derived from the biomass composition.

9. A process according to any preceding claim, wherein step (ii) of pulverising the biomass composition to provide a pulverised biomass powder with an average particle diameter (D50) of from 500 μm to 10,000 μm comprises crushing the biomass composition in a process involving the use of a negative pressure pneumatic conveyancing apparatus where the moisture content of the biomass composition is 20% by weight or less; preferably 18% by weight or less; and more preferably 15% by weight or less.

10. A process according to any preceding claim, wherein the process further comprises passing the pulverised biomass powder through a screen after pulverisation; optionally wherein the screen comprises apertures with a largest diameter of 8 mm or less; preferably 3 mm or less; and more preferably 3 mm or less.

11. A process according to any preceding claim, wherein the pulverised biomass powder has a particle size of from 500 μm to 8,000 μm; preferably from 500 μm to 5,000 μm.

12. A process according to any preceding claim, wherein step (iii) of drying the pulverised biomass powder so as to provide a dried pulverised biomass powder comprises drying the pulverised biomass in a drying cylinder.

13. A process according to claim 12, wherein the moisture content of the pulverised biomass powder is 20% by weight or less, and wherein the process comprises drying the pulverised biomass powder in a single drying cylinder.

14. A process according to claim 12, wherein the moisture content of the pulverised biomass powder is 20% by weight or more, and wherein the process comprises drying the pulverised biomass powder in multiple drying cylinders.

15. A process according to any preceding claim, wherein step (iv) of molding the dried pulverised biomass powder comprises adapting the molding step such that the density of the molded biomass product is controlled.

16. A process according to claim 15, wherein adapting the molding step such that the density of the molded biomass product is controlled comprises controlling the compression ratio of a mold used in said molding step.

17. A process according to any preceding claim, wherein step (iv) of molding the dried pulverised biomass powder so as to provide a molded biomass product comprises molding the pulverised biomass powder with a compression mold with a compression ratio of less than 6; and preferably less than 5.

18. A process according to any preceding claim, wherein step (iv) of molding the dried pulverised biomass powder so as to provide a molded biomass product comprises molding the pulverised biomass powder with a compression mold with a compression ratio of less than or equal to 3.5; preferably less than or equal to 3; and more preferably from 1 to 3.

19. A process according to any preceding claim, wherein an additive is added to the dried pulverised biomass powder prior to step (iv) of molding the dried compressed biomass powder.

20. A process according to any preceding claim, wherein step (v) of heating the molded biomass product is carried out for a time period of from 0.3 to 2.5 hours, and/or wherein the step of heating the molded biomass product comprises heating the molded biomass product to a temperature of from 220° C. to 350° C., optionally from 220° C. to 320° C.

21. A process according to any preceding claim wherein step (v) of heating the molded biomass product comprises heating the molded biomass product under conditions so as to induce torrefaction of the molded biomass product.

22. A process according to any preceding claim, wherein step (v) of heating the molded biomass product is adapted so as to control the uniformity of the solid biomass fuel, optionally wherein adapting step (v) so as to control the uniformity of the solid biomass fuel comprises conducting step (v) in an apparatus in which the molded biomass product is rotated whilst being heated, optionally, wherein adapting step (v) so as to control the uniformity of the solid biomass fuel comprises controlling the speed or direction of rotation of the molded biomass product, optionally wherein the molded biomass product is rotated in the apparatus in both an anticlockwise and clockwise direction.

23. A process according to any preceding claim, wherein the process further comprises a step of cooling the solid biomass fuel after heating step (v).

24. A process according to any preceding claim, wherein the process further comprises a step (vi) of removing dust particles from the solid biomass fuel.

25. A process according to claim 24, wherein step (vi) of removing dust particles from the solid biomass fuel comprises removing dust particles from the solid biomass fuel with a screen.

26. A process according to claim 25, wherein the screen has a pore size of from 2 mm to 8 mm, preferably wherein the screen has a pore size of from 2 mm to 5 mm, and more preferably wherein the screen has a pore size of from 2 mm to 3 mm.

27. A process according to any one of claims 24 to 26, wherein a drum sieve is used to as a screening device to remove the dust particles from the solid biomass fuel, preferably wherein the drum sieve comprises a rotating drum sieve.

28. A process according to any one of claims 24 to 27, wherein step (vi) of removing dust particles from the solid biomass fuel comprises subjecting the solid biomass fuel to vibration, rotation, rolling, or any combination thereof.

29. A process according to claim 28, wherein step (vi) of removing dust particles from the solid biomass fuel comprises using a vibrating screen, wherein the vibrating screen has a pore size of from 2 mm to 8 mm, preferably wherein the screen has a pore size of from 2 mm to 5 mm, and more preferably wherein the screen has a pore size of from 2 mm to 3 mm.

30. A process according to any preceding claim, wherein the bulk density of the solid biomass fuel as determined according to DIN EN 15103 is from 0.58 kg/l to 0.8 kg/l, preferably from 0.60 kg/l to 0.75 kg/l, and more preferably from 0.60 to 0.70 kg/L.

31. A process according to any preceding claim, wherein the mechanical durability of the solid biomass fuel as determined according to DIN EN 15210-1 is 97% or more; preferably 97.5% or more.

32. A process according to any preceding claim, wherein:
(i) the biomass composition consists essentially of rice straw, tobacco straw, pepper straw, aubergine straw, cassava straw, yellow bean straw, chickpea straw, Glycine max straw, or a combination thereof; and wherein the solid biomass fuel has a bulk density of from 0.50 kg/L to 0.68 kg/L, and wherein the mechanical durability of the solid biomass fuel is 97% or higher;
(ii) the biomass composition consists essentially of palm leaves, and wherein the solid biomass fuel has a bulk density of from 0.60 kg/L to 0.70 kg/L, and wherein the mechanical durability of the solid biomass fuel is 97.5% or higher;
(iii) the biomass composition consists essentially of cashew shells, Chinese chestnut shells, pistachio shells, sunflower seed shells, walnut shells, pine nut shells, or a combination thereof, and wherein the solid biomass fuel has a bulk density of from 0.62 kg/L to 0.73 kg/L, and wherein the mechanical durability of the solid biomass fuel is 97.8% or higher;
(iv) the biomass composition consists essentially of hemp, and wherein the solid biomass fuel has a bulk density of from 0.65 kg/L to 0.68 kg/L, and wherein the mechanical durability of the solid biomass fuel is 97.5% or higher;
(v) the biomass composition consists essentially moso bamboo, hemp bamboo, arrow bamboo, or a combination thereof, and wherein the solid biomass fuel has a bulk density of from 0.62 kg/L to 0.67 kg/L, and wherein the mechanical durability of the solid biomass fuel is 97.5% or higher;
(vi) the biomass composition consists essentially of lychee shells, cinnamon (logan) shells, snake skin fruit shells, mangosteen shells, durian shells, or a combination thereof and wherein the solid biomass fuel has a bulk density of from 0.62 kg/L to 0.67 kg/L, and wherein the mechanical durability of the solid biomass fuel is 97.5% or higher;
(vii) the biomass composition consists essentially of, soybean residue, peanut residue, cassava residue, sweet potato residue, coffee bean residue, or combinations thereof, and wherein the solid biomass fuel has a bulk density of from 0.62 kg/L to 0.69 kg/L, and wherein the mechanical durability of the solid biomass fuel is 97.5% or higher;
wherein the bulk density is determined according to DIN EN 15103, and wherein the mechanical durability is determined according to DIN EN 15210-1.

33. A process according to any preceding claim, wherein (i) the total dry sulphur content of the biomass solid fuel is 0.5 wt % or less, preferably 0.45 wt % or less, and most preferably 0.40 wt % or less, wherein the total dry sulphur content is determined according to DIN EN 15289; (ii) the total dry hydrogen content of the biomass solid fuel is 3 wt % or more, preferably from 5 wt % to 10 wt %, and more preferably from 5 wt % to 7 wt %, wherein the total dry hydrogen content is determined according to DIN EN 15104; (iii) the total dry oxygen content of the biomass solid fuel is 20 wt % or more, preferably from 25 wt % to 42 wt %, more preferably from 28 wt % to 40 wt %, wherein the total dry oxygen content is determined according to DIN EN 15296; (iv) the total dry carbon content of the biomass solid fuel is 40 wt % or more, preferably from 45 wt % to 65 wt %, and more preferably from 50 wt % to 60 wt %, wherein total dry carbon content is determined according to DIN EN 15104; and/or (v) the total dry nitrogen content of the biomass solid fuel is less than 5.0 wt %, preferably less than 3.0 wt % and more preferably less than 2.5 wt %, wherein the total dry nitrogen content is determined according to DIN EN 15104.

34. A process according to any preceding claim, wherein (i) the chemical oxygen demand (COD) of the solid biomass fuel when immersed in water is 5000 ppm or less, preferably 4000 ppm or less, and most preferably 3200 ppm or less, wherein the chemical oxygen demand is determined according to GB/11914-89; (ii) the fixed carbon content of the solid biomass fuel is 20 wt % or more, preferably from 25 wt % to 45 wt %, wherein the fixed carbon content is determined according to DIN EN 51734; (iii) the ash content of the solid biomass fuel is less than 20 wt %, preferably less than 18 wt %, wherein the ash content is determined according to EN 14775 at 550° C.; (iv) the volatile matter content of the solid biomass fuel is from 35 wt % to 80 wt %, more preferably from 40 wt % to 75 wt %, wherein the volatile matter content is determined according to DIN EN 15148; and/or (v) the internal moisture content of the solid biomass fuel is less than 8 wt %, preferably less than 6 wt %, and more preferably less than 5 wt %, wherein the internal moisture content is determined according to DIN EN 14774.

35. A process according to any preceding claim, wherein the biomass solid fuel has a calorific value of from 4300 kcal/kg to 6750 kcal/kg, wherein the calorific value is determined in accordance with DIN EN 14918.

36. A process according to any preceding claim, wherein the biomass solid fuel has a base moisture content of less than 10 wt %, preferably less than 8 wt %, and most preferably less than 6 wt %, wherein the base moisture content is determined according to GB/T211-2017.

37. A process according to any preceding claim, wherein the pH of the solid biomass fuel is from 4 to 10.

38. A process according to any preceding claim, wherein the coke residue of the solid biomass fuel upon combustion is 1 to 4, preferably from 2 to 3.

39. A process according to any preceding claim, wherein the solid biomass fuel is waterproof for up to 20 days, preferably up to 30 days, and more preferably up to 40 days.

40. A process according to any preceding claim, wherein the PM1.0 emissions of the solid biomass fuel upon combustion is less than 175 mg/kg, preferably less than 150 mg/kg.

41. A process according to any preceding claim, wherein the bulk density of the molded biomass product is A, and the bulk density of the biomass solid fuel is B, and wherein B/A is 0.55 to 1, wherein the bulk density is determined in accordance with DIN EN 15103.

42. A process according to any preceding claim, wherein material derived from biomass is present in the solid biomass fuel in an amount of at least 90% by weight of the total fuel content of the solid biomass fuel.

43. A solid biomass fuel obtainable or obtained by a process according to any preceding claim.

44. A solid biomass fuel derived from a biomass composition, wherein the biomass composition comprises: rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

45. A solid biomass fuel according to claim 44, wherein the biomass composition consists essentially of rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

46. A solid biomass fuel according to claim 44 or claim 45, wherein the solid biomass fuel consists essentially of material derived from the biomass composition.

47. A solid biomass fuel according to any one of claims 43 to 46, wherein the biomass composition or solid biomass fuel are as further defined in any one or more of claims 1 to 42.

48. A combustion process comprising the step of combusting a solid biomass fuel in accordance with any one of claims 43 to 47 so as to produce energy.

49. A process according to claim 48, wherein the solid biomass composition fuel is co-fired and combusted alongside a fossil fuel such as coal.

50. A process according to claim 48 or claim 49, wherein the PM1.0 emissions of the process are less than 175 mg/kg, and preferably less than 150 mg/kg.

51. Use of a solid biomass fuel according to any one of claims 43 to 47 as a fuel in a combustion process, optionally wherein the use comprises using the solid biomass fuel in a process according to any one of claims 47 to 50.

52. Use of a biomass composition to produce a solid biomass composition fuel, wherein the biomass composition comprises, consists of, or consists essentially of rice straw, tobacco straw, pepper straw, aubergine straw, cassava straw, yellow bean straw, chick pea straw, Glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof.

53. Use according to claim 52, wherein the use comprises using the biomass composition in a process according to any one of claims 1 to 42, and/or wherein the solid biomass fuel is as defined in any one of claims 43 to 47.
